(19) United States
(12) Patent Application Publication
(10) Pub. No.: US 2026/0190090 A1
(43) Pub. Date: Jul. 2, 2026

(54) DATA TRANSMISSION METHOD, COMMUNICATION NODE AND STORAGE MEDIUM

(71) Applicant: ZTE CORPORATION, Shenzhen (CN)

(72) Inventors: Jie CHEN, Shenzhen (CN); Youxiong LU, Shenzhen (CN); Ting MIAO, Shenzhen (CN); Weimin XING, Shenzhen (CN); Haigang HE, Shenzhen (CN); Feng BI, Shenzhen (CN)

(21) Appl. No.: 19/130,708

(22) PCT Filed: Dec. 7, 2023
(86) PCT No.: PCT/CN2023/137026

§ 371 Date: May 16, 2025

(30) Foreign Application Priority Data
Dec. 12, 2022 (CN) 202211599338.4

(51) Int. Cl. H04W 72/0446; H04W 72/0453; H04W 72/25; H04W 72/40

(52) U.S. Cl. CPC H04W 72/0446; H04W 72/0453; H04W 72/25; H04W 72/40

(57) ABSTRACT

Provided are a data transmission method, a communication node, and a storage medium. The method includes acquiring resource pool configuration information and semi-static channel occupancy information; determining a resource position and a transmission mode of a channel based on the resource pool configuration information and the semi-static channel occupancy information, where the channel is a data channel or a feedback channel; transmitting data at the resource position according to the transmission mode.

### TECHNICAL FIELD

The present application relates to the field of communication technology, for example, to a data transmission method, a communication node, and a storage medium.

### BACKGROUND

Currently, the 3GPP (3rd Generation Partnership Project) system supports channel access in unlicensed frequency bands through two methods, that is, load-based dynamic channel occupancy and frame-based semi-static channel occupancy. Typically, semi-static channel occupancy involves a semi-static occupancy period and an idle period within the semi-static occupancy period of a device. When a sidelink (SL) device operates in an unlicensed frequency band under a traditional resource pool configuration, the SL device needs to further consider the channel occupancy requirements within the semi-static occupancy period and the impact of the idle period on the transmission of various channels or signals in the SL resource pool. Therefore, how SL devices transmit SL channels or signals under these influences is a pressing issue that needs to be addressed.

### SUMMARY

Embodiments of the present application provide a data transmission method. The method includes the following:

Resource pool configuration information and semi-static channel occupancy information are acquired.

A resource position and a transmission mode of a channel are determined based on the resource pool configuration information and the semi-static channel occupancy information, where the channel is a data channel or a feedback channel.

Data is transmitted at the resource position according to the transmission mode.

Embodiments of the present application provide a communication node. The communication node includes a processor that, when executing a computer program, implements the method of any of the preceding embodiments.

Embodiments of the present application also provide a computer-readable storage medium storing a computer program that, when executed by a processor, implements the method of any of the preceding embodiments.

The preceding embodiments and other aspects of the present application and implementations thereof are described in more detail in the description of drawings, detailed description, and claims.

### BRIEF DESCRIPTION OF DRAWINGS

FIG. 1 is a timing diagram of a semi-static channel occupancy device according to an embodiment.

FIG. 2 is a schematic diagram of SL communication according to an embodiment.

FIG. 3 is a schematic diagram of a time-domain resource configuration of an SL resource pool according to an embodiment.

FIG. 4 is a diagram illustrating the structure of an SL slot without a PSFCH according to an embodiment.

FIG. 5 is a diagram illustrating the structure of an SL slot with a PSFCH according to an embodiment.

FIG. 6 is a diagram illustrating the structure of multiple SL slots according to an embodiment.

FIG. 7 is a schematic diagram of an SL resource pool according to an embodiment.

FIG. 8 is a flowchart of a data transmission method according to an embodiment.

FIG. 9 is a schematic diagram of a first method for determining a resource position and a transmission mode of a channel according to an embodiment.

FIG. 10 is a schematic diagram of a second method for determining a resource position and transmission mode of a channel according to an embodiment.

FIG. 11 is a schematic diagram of a third method for determining a resource position and transmission mode of a channel according to an embodiment.

FIG. 12 is a schematic diagram of a fourth method for determining a resource position and a transmission mode of a channel according to an embodiment.

FIG. 13 is a schematic diagram of a fifth method for determining a resource position and transmission mode of a channel according to an embodiment.

FIG. 14 is a schematic diagram of a sixth method for determining a resource position and transmission mode of a channel according to an embodiment.

FIG. 15 is a schematic diagram of a seventh method for determining a resource position and a transmission mode of a channel according to an embodiment.

FIG. 16 is a schematic diagram of an eighth method for determining a resource position and transmission mode of a channel according to an embodiment.

FIG. 17 is a schematic diagram of a ninth method for determining a resource position and transmission mode of a channel according to an embodiment.

FIG. 18 is a diagram illustrating the structure of a data transmission apparatus according to an embodiment.

FIG. 19 is a diagram illustrating the structure of a UE according to an embodiment.

FIG. 20 is a diagram illustrating the structure of a base station (or higher-layer entity) according to an embodiment.

### DETAILED DESCRIPTION

It is to be understood that the specific embodiments described herein are intended to explain the present application and not to limit the present application. Embodiments of the present application are described hereinafter in detail in conjunction with drawings.

On a channel of approximately 20 megahertz (MHz), when a device is configured to access the channel in an unlicensed spectrum using a semi-static channel occupancy mode, the device is typically configured with a channel occupancy period (period UE) and an offset relative to a starting position. An idle period (also referred to as idle time) is predefined at the end of the channel occupancy period for Listen Before Talk (LBT) of channel occupancy in the next channel occupancy period. The time-domain length of the idle period is generally max (0.05*period UE, 100 μs).

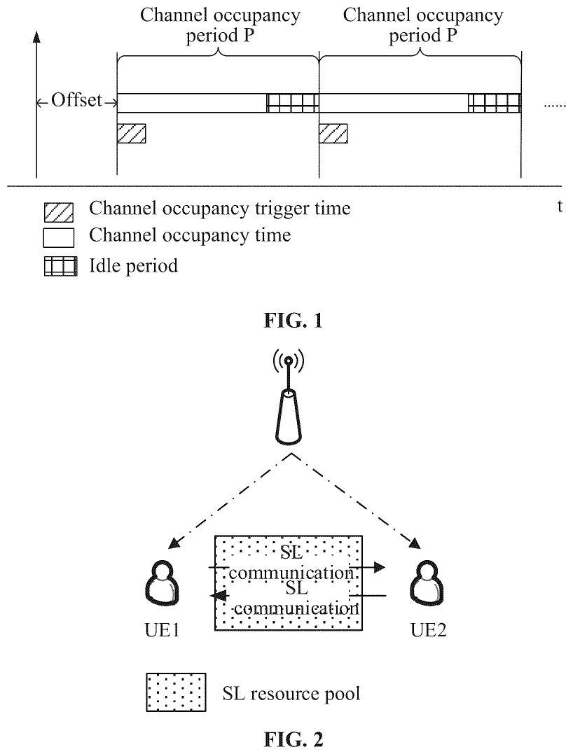

FIG. 1 is a timing diagram of a semi-static channel occupancy device according to an embodiment. As shown in FIG. 1, the condition for a device to transmit data during the channel occupancy time within the channel occupancy period is as follows: The device successfully performs LBT during the idle period before the channel occupancy period and transmits signals at the starting position of the channel occupancy period; or the device receives channel occupancy time (COT) sharing information from another device within the channel occupancy period and transmits data based on the COT sharing information.

The 3GPP New Radio (NR) Release 16 and 17 protocols define SL communication between devices. SL communication includes vehicle-to-vehicle (V2V) communication, vehicle-to-anything (V2X) communication, and direct device-to-device (D2D) communication between user equipments (UEs). FIG. 2 is a schematic diagram of SL communication according to an embodiment. As shown in FIG. 2, when a service needs to be transmitted between UEs, the UEs communicate based on an SL resource pool. The service data can be transmitted directly from the data source device to the target device without being forwarded through other network devices (such as a base station), thus enabling direct communication between devices.

The data transmission method provided by the present application can be applied to SL communication systems based on various wireless communication technologies, such as those based on Long-Term Evolution (LTE) technology, 4th-generation (4G) mobile communication technology, 5th-generation (5G) mobile communication technology, LTE and 5G hybrid technology, 5G NR technology, and emerging communication technologies in future developments, such as 6th-generation (6G) mobile communication technology.

In the embodiments of the present application, a data transmission method, a communication node, and a storage medium are provided to address the impact of the semi-static channel access configuration of a device in an unlicensed spectrum on SL channels, channel resources, and transmission.

First, the concepts involved in the following embodiments of the present application are explained.

The SL resource pool is determined through higher-layer configuration or preconfigured signaling, and resources for the sidelink synchronization signal block (S-SSB) outside the resource pool are determined through higher-layer configuration or preconfigured signaling. The SL resource pool configuration includes time-domain resource configuration, frequency-domain resource configuration, and other parameter configurations such as a control channel and a feedback channel within the SL resource pool. In an embodiment, within the SL resource pool, an SL UE may acquire physical layer resource grant information through mode 1 (base station scheduling) or mode 2 (UE autonomous resource selection) and perform data transmission.

For the time-domain resource configuration of the SL resource pool, the 3GPP protocol defines time-domain resources within a radio frame period of 10,240 ms. After excluding certain special slots, the remaining slots are mapped via a bitmap to obtain the final time-domain resources of the SL resource pool. The special slots include the following: (1) Slots for the S-SSB configured or preconfigured by the system, (2) Slots unavailable for SL, such as some downlink (DL) slots, and (3) Reserved slots.

Exemplarily, an example is used where the subcarrier spacing (SCS) is 15 kHz. FIG. 3 is a schematic diagram of a time-domain resource configuration of an SL resource pool according to an embodiment.

In an embodiment, within an SL slot, the slot symbols available for SL signal transmission are determined by the configured or preconfigured signaling parameters sl-StartSymbol and sl-LengthSymbols. Further, a physical sidelink feedback channel (PSFCH) may be configured within the SL slot, the PSFCH symbol position within the slot is startSLsymbols+lengthSLsymbols−2, and repeated transmission occurs on the symbol startSLsymbols+lengthSLsymbols−3. Therefore, the PSFCH on SL is generally transmitted on two consecutive symbols within the slot.

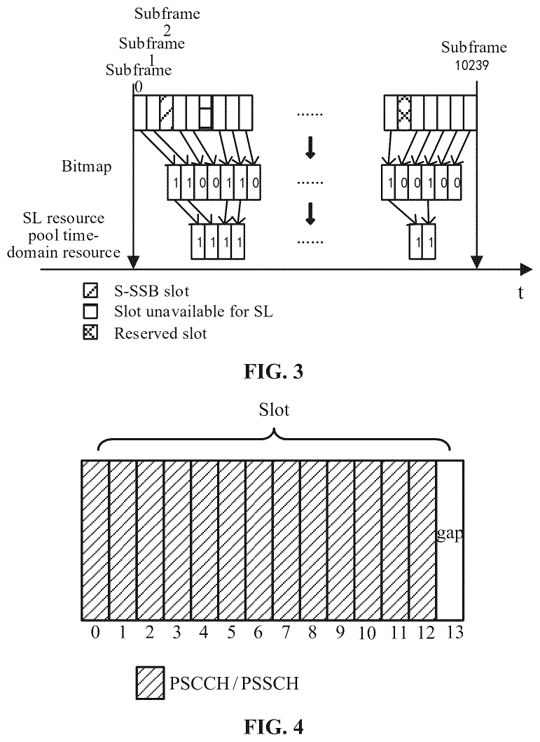

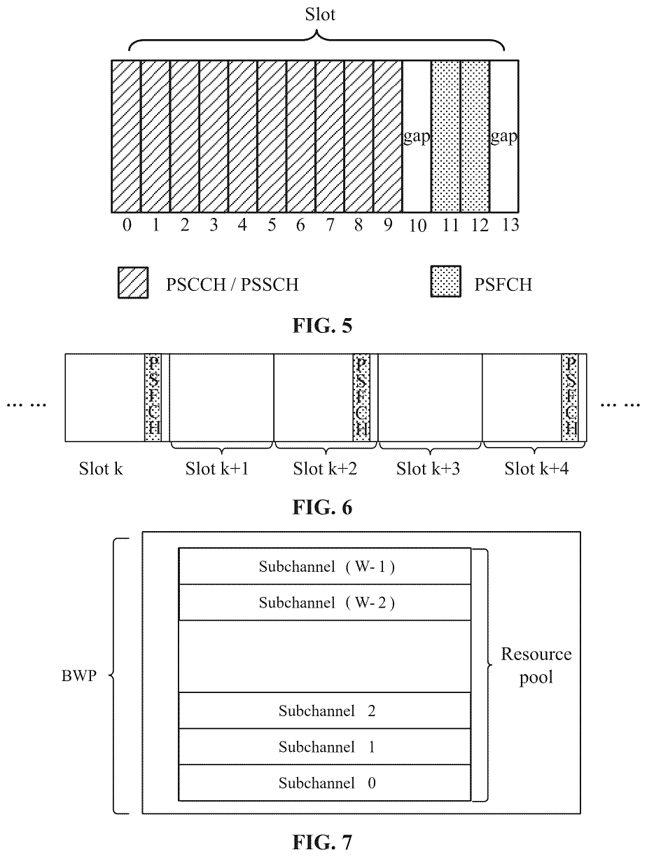

FIG. 4 is a diagram illustrating the structure of an SL slot without a PSFCH according to an embodiment. FIG. 5 is a diagram illustrating the structure of an SL slot with a PSFCH according to an embodiment. As shown in FIG. 4, an SL slot typically includes 14 consecutive symbols, one null symbol (gap symbol) occupies one symbol, and the physical sidelink control channel (PSCCH) symbols/physical sidelink shared channel (PSSCH) symbols occupy up to 13 symbols. Similarly, as shown in FIG. 5, the PSCCH symbols/PSSCH symbols occupy up to 10 symbols.

In an embodiment, the time-domain resources of the PSFCH are distributed within the slots of the SL resource pool according to a configured or preconfigured period. FIG. 6 is a diagram illustrating the structure of multiple SL slots according to an embodiment. As shown in FIG. 6, when the PSFCH period is 2, a PSFCH transmission resource is configured or preconfigured every 2 slots within the SL resource pool.

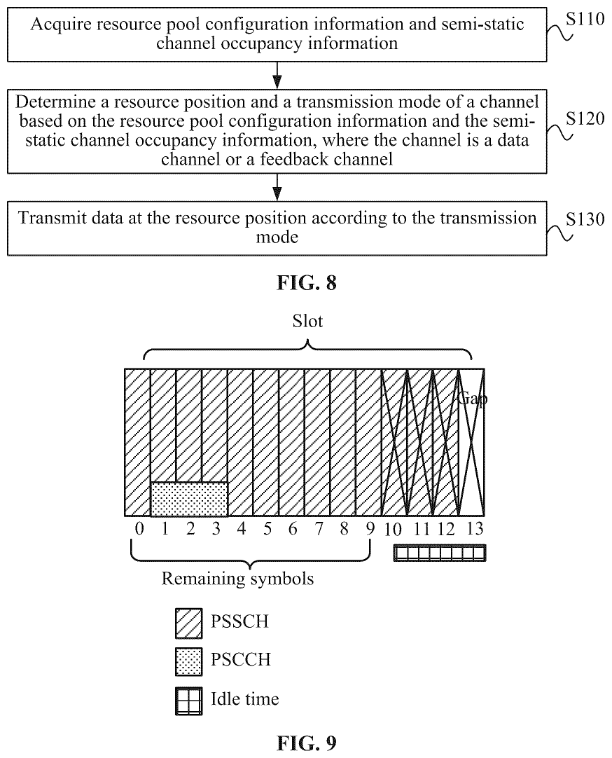

In an embodiment, for the frequency-domain resource configuration of the SL resource pool, the SL resource pool includes W subchannels, where one subchannel typically corresponds to a group of consecutive physical resource blocks (PRBs) or a group of discrete PRBs. In one communication instance, an SL device selects L subchannels in the SL resource pool to transmit the PSSCH. An example is used where the communication is performed based on a subchannel composed of consecutive PRBs. FIG. 7 is a schematic diagram of an SL resource pool according to an embodiment.

In the embodiments of the present application, “configuration” generally refers to the method by which a base station, an access point, a central node, a higher-layer entity, or another network-side entity (collectively referred to as the network side) notifies the UE of configuration signaling; “preconfiguration” generally refers to configuration information or default configuration information pre-stored in the UE before leaving the factory. In an embodiment, the pre-configuration may be updated by the network side or other means. “Predefined” refers to configurations or parameters explicitly specified in the protocol, which cannot be updated. In the following embodiments of the present application, no distinction is made between configuration, preconfiguration, and predefinition, and the three are collectively referred to as “configuration”.

In an embodiment, the network side may configure SL communication to use an unlicensed band in a semi-static manner. The following embodiments may also assume that the usage mode or pattern of the unlicensed band is configured as semi-static.

In the embodiments of the present application, “transmission” may refer to the process of a source device sending data to a target device or the process of a target device receiving data from a source device.

In the embodiments of the present application, a first preset relationship corresponds to a “less than” relationship, and a second preset relationship corresponds to a “greater than or equal to” relationship; alternatively, a first preset relationship corresponds to a “less than or equal to” relationship, and a second preset relationship corresponds to a “greater than” relationship. For example, if A and B satisfy a first preset relationship and C and D satisfy a second preset relationship, this can be understood as A being less than B and C being greater than or equal to D, or as A being less than or equal to B and C being greater than D.

The data transmission method, communication node, and technical effects thereof are described below.

FIG. 8 is a flowchart of a data transmission method according to an embodiment. As shown in FIG. 8, the method provided in this embodiment is applicable to a first communication node. In this example, the first communication node (also referred to as the first communication node device or first node) may be a source device, and the second communication node (also referred to as the second communication node device or second node) may be a target device; alternatively, the first communication node may be a target device, and the second communication node may be a source device. For ease of understanding, in the following embodiments, the first communication node is denoted as UE1, and the second communication node is denoted as UE2. The method includes S110 to S130.

In S110, resource pool configuration information and semi-static channel occupancy information are acquired.

In an embodiment, the resource pool configuration information includes at least one of the following: a time-domain resource configuration parameter of an SL resource pool, a frequency-domain subband resource configuration parameter of an SL resource pool, a control channel configuration parameter of an SL resource pool, a data channel configuration parameter of an SL resource pool, a feedback channel configuration parameter of an SL resource pool, or a configuration parameter of a symbol within a slot of an SL resource pool.

In an embodiment, the semi-static channel occupancy information includes at least one of the following: a channel occupancy period, a first offset offset1 of a channel occupancy period, information about a trigger signal within a channel occupancy period, or information about an idle time within a channel occupancy period.

For the trigger signal within the channel occupancy period, the information about the trigger signal within the channel occupancy period includes at least one of a time-domain position of the trigger signal or a time-domain length of the trigger signal.

The starting position of the trigger signal is the sum of the starting position of the channel occupancy period and a second offset offset2 of the trigger signal.

The time-domain length of the trigger signal is N symbols, where N is a positive integer.

For the idle time within the channel occupancy period, the information about the idle time within the channel occupancy period includes at least one of a time-domain position of the idle time or a time-domain length of the idle time.

The ending position of the idle time is the sum of the ending position of the channel occupancy period and a third offset offset3 of the idle time. Alternatively, the starting position of the idle time is the sum of the ending position of the channel occupancy period and a third offset offset3 of the idle time. Alternatively, the starting position of the idle time is the sum of the starting position of the channel occupancy period and a third offset offset3 of the idle time. Alternatively, the time-domain position of the idle time is a predefined time-domain position.

In an embodiment, the semi-static channel occupancy information may include at least one of the following: a frequency-domain resource position of a trigger signal within a channel occupancy period, or a format of a trigger signal within a channel occupancy period.

The frequency-domain resource position of the trigger signal is a group of consecutive PRBs within a configured, preconfigured, or predefined resource block set (RB set), a group of discrete PRBs, all PRBs on an interlace, or part of PRBs on an interlace.

The format of the trigger signal includes a PSCCH, a PSSCH, a PSFCH, a channel state information-reference signal (CSI-RS), an S-SSB, a predefined sequence, and a cyclic prefix extension (CPE).

In an embodiment, the frequency-domain resource position of the trigger signal is orthogonal to a frequency-domain resource of a PSFCH; the frequency-domain resource position of the trigger signal is orthogonal to a frequency-domain resource of an S-SSB.

In an embodiment, if the time-domain position of the trigger signal overlaps with a time-domain resource position of the data, the trigger signal is not transmitted at an overlapping time-domain resource position.

In S120, a resource position and a transmission mode of a channel are determined based on the resource pool configuration information and the semi-static channel occupancy information, where the channel is a data channel or a feedback channel.

Specifically, the method of “determining a resource position and a transmission mode of a channel based on the resource pool configuration information and the semi-static channel occupancy information” in S120 may include two operations as follows.

In operation 1, an availability rule of the channel is determined based on the resource pool configuration information and the semi-static channel occupancy information.

In an embodiment, the semi-static channel occupancy information includes a channel occupancy period and a first offset offset1 of a channel occupancy period, and the availability rule includes a first availability rule, a second availability rule, and a third availability rule. The above operation 1 may be executed according to any of the following principles:

Principle 1: If an idle time position within the channel occupancy period overlaps in the time domain only with a PSSCH within a slot of a resource pool, the first availability rule is determined.

Exemplarily, the first availability rule includes at least one of the following:

If the number of time-domain symbols overlapping between the idle time position within the channel occupancy period and a PSSCH at a determined resource position within the slot and a first preset threshold satisfy a first preset relationship, the PSSCH within the slot is allowed to be used for puncturing transmission or rate-matching transmission.

If the number of time-domain symbols overlapping between the idle time position within the channel occupancy period and a PSSCH at a determined resource position within the slot and the first preset threshold satisfy the first preset relationship, and no time-domain overlap exists between the idle time position within the channel occupancy period and a PSCCH associated with the PSSCH with the determined resource position within the slot, the PSSCH within the slot is allowed to be used for puncturing transmission or rate-matching transmission.

If the number of time-domain symbols overlapping between the idle time position within the channel occupancy period and a PSSCH at a determined resource position within the slot and the first preset threshold satisfy a second preset relationship, or a time-domain overlap exists between the idle time position within the channel occupancy period and a PSCCH associated with a PSSCH at a determined resource position within the slot, the PSSCH transmission within the slot is dropped.

If the number of time-domain symbols overlapping between the idle time position within the channel occupancy period and a PSSCH at a determined resource position within the slot and the first preset threshold satisfy the second preset relationship, or a time-domain overlap exists between the idle time position within the channel occupancy period and a PSCCH associated with a PSSCH at a determined resource position within the slot, resource reselection in a higher-layer of a device is triggered.

If the number of time-domain symbols overlapping between the idle time position within the channel occupancy period and a PSSCH at a determined resource position within the slot and the first preset threshold satisfy the second preset relationship, or a time-domain overlap exists between the idle time position within the channel occupancy period and a PSCCH associated with a PSSCH at a determined resource position within the slot, a device is triggered to transmit a scheduling request (SR) or a buffer status report (BSR).

If the number of time-domain symbols overlapping between the idle time position within the channel occupancy period and a candidate PSSCH resource within the slot and the first preset threshold satisfy the second preset relationship, or a time-domain overlap exists between the idle time position within the channel occupancy period and a PSCCH resource associated with a candidate PSSCH resource within the slot, all candidate PSSCH resources on the slot are excluded from an initial candidate PSSCH resource set of a physical layer.

If the number of time-domain symbols overlapping between the idle time position within the channel occupancy period and a candidate PSSCH resource within the slot and the first preset threshold satisfy the second preset relationship, or a time-domain overlap exists between the idle time position within the channel occupancy period and a PSCCH resource associated with a candidate PSSCH resource within the slot, all candidate PSSCH resources on the slot are excluded from a sensed candidate resource set to be reported of the physical layer.

If the number of time-domain symbols overlapping between the idle time position within the channel occupancy period and a candidate PSSCH resource within the slot and the first preset threshold satisfy the second preset relationship, or a time-domain overlap exists between the idle time position within the channel occupancy period and a PSCCH resource associated with a candidate PSSCH resource within the slot, all candidate PSSCH resources on the slot are excluded from a candidate resource set within a resource selection window of a medium access control (MAC) layer.

If the number of available PSSCH symbols, which remain in the slot and exclude symbols overlapping between the idle time position within the channel occupancy period and a PSSCH at a determined resource position within the slot, and a second preset threshold satisfy the second preset relationship, the PSSCH within the slot is allowed to be used for puncturing transmission or rate-matching transmission.

If the number of available PSSCH symbols, which remain in the slot and exclude symbols overlapping between the idle time position within the channel occupancy period and a PSSCH at a determined resource position within the slot, and the second preset threshold satisfy the second preset relationship, and no time-domain overlap exists between the idle time position within the channel occupancy period and a PSCCH associated with the PSSCH with the determined resource position within the slot, the PSSCH within the slot is allowed to be used for puncturing transmission or rate-matching transmission.

If the number of available PSSCH symbols, which remain in the slot and exclude symbols overlapping between the idle time position within the channel occupancy period and a PSSCH at a determined resource position within the slot, and the second preset threshold satisfy the first preset relationship, or a time-domain overlap exists between the idle time position within the channel occupancy period and a PSCCH associated with a PSSCH at a determined resource position within the slot, the PSSCH transmission within the slot is dropped.

If the number of available PSSCH symbols, which remain in the slot and exclude symbols overlapping between the idle time position within the channel occupancy period and a PSSCH at a determined resource position within the slot, and the second preset threshold satisfy the first preset relationship, or a time-domain overlap exists between the idle time position within the channel occupancy period and a PSCCH associated with a PSSCH at a determined resource position within the slot, resource reselection in a higher-layer of the device is triggered.

If the number of available PSSCH symbols, which remain in the slot and exclude symbols overlapping between the idle time position within the channel occupancy period and a PSSCH at a determined resource position within the slot, and the second preset threshold satisfy the first preset relationship, or a time-domain overlap exists between the idle time position within the channel occupancy period and a PSCCH associated with a PSSCH at a determined resource position within the slot, a device is triggered to transmit an SR or a BSR.

If the number of available PSSCH symbols, which remain in the slot and exclude symbols overlapping between the idle time position within the channel occupancy period and a PSSCH at a determined resource position within the slot, and the second preset threshold satisfy the first preset relationship, or a time-domain overlap exists between the idle time position within the channel occupancy period and a PSCCH resource associated with a candidate PSSCH resource within the slot, all candidate PSSCH resources on the slot are excluded from an initial candidate PSSCH resource set of a physical layer.

If the number of available PSSCH symbols, which remain in the slot and exclude symbols overlapping between the idle time position within the channel occupancy period and a PSSCH at a determined resource position within the slot, and the second preset threshold satisfy the first preset relationship, or a time-domain overlap exists between the idle time position within the channel occupancy period and a PSCCH resource associated with a candidate PSSCH resource within the slot, all candidate PSSCH resources on the slot are excluded from a sensed candidate resource set to be reported of the physical layer.

If the number of available PSSCH symbols, which remain in the slot and exclude symbols overlapping between the idle time position within the channel occupancy period and a PSSCH at a determined resource position within the slot, and the second preset threshold satisfy the first preset relationship, or a time-domain overlap exists between the idle time position within the channel occupancy period and a PSCCH resource associated with a candidate PSSCH resource within the slot, all candidate PSSCH resources on the slot are excluded from a candidate resource set within a resource selection window of a MAC layer.

Principle 2: If an idle time position within the channel occupancy period overlaps in the time domain only with a PSFCH within a slot of the resource pool, the second availability rule or the third availability rule is determined.

Specifically, when the idle time position within the channel occupancy period overlaps in the time domain only with a PSFCH within a slot of the resource pool and only the PSFCH resource is considered, the second availability rule is determined; when the idle time position within the channel occupancy period overlaps in the time domain only with a PSFCH within a slot of the resource pool and the impact of PSFCH movement on the PSSCH is considered, the third availability rule is determined.

Exemplarily, the second availability rule includes at least one of the following: a time-domain position of a PSFCH transmission is shifted within the slot; a time-domain position of a PSFCH transmission is shifted between slots; the slot is excluded from the resource pool when time-domain resources of the PSFCH are mapped; or a PSFCH transmission in the slot is stopped.

Exemplarily, the third availability rule includes at least one of the following:

If a time-domain position of a PSFCH transmission is shifted within the slot, and no time-domain overlap exists between a shifted time-domain position of the PSFCH transmission and a PSCCH associated with a PSSCH at a determined resource position within the slot, and the number of available PSSCH symbols remaining in the slot after the shift and a second preset threshold satisfy a second preset relationship, the remaining PSSCH symbols in the slot are allowed to be used for puncturing transmission or rate-matching transmission.

If a time-domain position of a PSFCH transmission is shifted within the slot, and the number of available PSSCH symbols remaining in the slot after the shift and the second preset threshold satisfy the second preset relationship, the remaining PSSCH symbols in the slot are allowed to be used for puncturing transmission or rate-matching transmission.

If a time-domain position of a PSFCH transmission is shifted within the slot, and a time-domain overlap exists between a shifted time-domain position of the PSFCH transmission and a PSCCH associated with a PSSCH at a determined resource position within the slot, or the number of available PSSCH symbols remaining in the slot after the shift and the second preset threshold satisfy a first preset relationship, the PSSCH transmission within the slot is dropped.

If a time-domain position of a PSFCH transmission is shifted within the slot, and a time-domain overlap exists between a shifted time-domain position of the PSFCH transmission and a PSCCH associated with a candidate PSSCH resource within the slot, or the number of available symbols of the candidate PSSCH resource remaining in the slot after the shift and the second preset threshold satisfy the first preset relationship, all candidate PSSCH resources on the slot are excluded from an initial candidate PSSCH resource set of a physical layer.

If a time-domain position of a PSFCH transmission is shifted within the slot, and a time-domain overlap exists between a shifted time-domain position of the PSFCH transmission and a PSCCH associated with a candidate PSSCH resource within the slot, or the number of available symbols of a candidate PSSCH resource remaining in the slot after the shift and the second preset threshold satisfy the first preset relationship, all candidate PSSCH resources on the slot are excluded from a sensed candidate resource set to be reported of the physical layer.

If a time-domain position of a PSFCH transmission is shifted within the slot, and a time-domain overlap exists between a shifted time-domain position of the PSFCH transmission and a PSCCH associated with a candidate PSSCH resource within the slot, or the number of available symbols of a candidate PSSCH resource remaining in the slot after the shift and the second preset threshold satisfy the first preset relationship, all candidate PSSCH resources on the slot are excluded from a candidate resource set within a resource selection window of a MAC layer.

If a time-domain position of a PSFCH transmission is shifted within the slot, and a time-domain overlap exists between a shifted time-domain position of the PSFCH transmission and a PSCCH associated with a PSSCH at a determined resource position within the slot, or the number of available PSSCH symbols remaining in the slot after the shift and the second preset threshold satisfy the first preset relationship, resource reselection in a higher-layer of a device is triggered.

If a time-domain position of a PSFCH transmission is shifted within the slot, and a time-domain overlap exists between a shifted time-domain position of the PSFCH transmission and a PSCCH associated with a PSSCH at a determined resource position within the slot, or the number of available PSSCH symbols remaining in the slot after the shift and the second preset threshold satisfy the first preset relationship, a device is triggered to transmit an SR or a BSR.

If the number of time-domain symbols overlapping between the idle time position within the channel occupancy period and a PSSCH at a determined resource position within the slot and a third preset threshold satisfy the first preset relationship, and a time-domain position of a PSFCH transmission is shifted within the slot, the PSSCH within the slot is allowed to be used for puncturing transmission or rate-matching transmission.

If the number of time-domain symbols overlapping between the idle time position within the channel occupancy period and a PSSCH at a determined resource position within the slot and the third preset threshold satisfy the first preset relationship, and a time-domain position of a PSFCH transmission is shifted within the slot, and no time-domain overlap exists between a shifted time-domain position of the PSFCH transmission and a PSCCH associated with the PSSCH with the determined resource position within the slot, the PSSCH within the slot is allowed to be used for puncturing transmission or rate-matching transmission.

If the number of time-domain symbols overlapping between the idle time position within the channel occupancy period and a PSSCH at a determined resource position within the slot and the third preset threshold satisfy a second preset relationship, or a time-domain position of a PSFCH transmission is shifted within the slot and a time-domain overlap exists between a shifted time-domain position of the PSFCH transmission and a PSCCH associated with a PSSCH at a determined resource position within the slot, the PSSCH transmission within the slot is dropped.

If the number of time-domain symbols overlapping between the idle time position within the channel occupancy period and a PSSCH at a determined resource position within the slot and the third preset threshold satisfy the second preset relationship, or a time-domain position of a PSFCH transmission is shifted within the slot and a time-domain overlap exists between a shifted time-domain position of the PSFCH transmission and a PSCCH associated with a PSSCH at a determined resource position within the slot, resource reselection in a higher-layer of a device is triggered.

If the number of time-domain symbols overlapping between the idle time position within the channel occupancy period and a PSSCH at a determined resource position within the slot and the third preset threshold satisfy the second preset relationship, or a time-domain position of a PSFCH transmission is shifted within the slot and a time-domain overlap exists between a shifted time-domain position of the PSFCH transmission and a PSCCH associated with a PSSCH at a determined resource position within the slot, a device is triggered to transmit an SR or a BSR.

If the number of time-domain symbols overlapping between the idle time position within the channel occupancy period and a candidate PSSCH resource within the slot and the third preset threshold satisfy the second preset relationship, or a time-domain position of a PSFCH transmission is shifted within the slot and a time-domain overlap exists between a shifted time-domain position of the PSFCH transmission and a PSCCH associated with a candidate PSSCH resource within the slot, all candidate PSSCH resources on the slot are excluded from an initial candidate PSSCH resource set of a physical layer.

If the number of time-domain symbols overlapping between the idle time position within the channel occupancy period and a candidate PSSCH resource within the slot and the third preset threshold satisfy the second preset relationship, or a time-domain position of a PSFCH transmission is shifted within the slot and a time-domain overlap exists between a shifted time-domain position of the PSFCH transmission and a PSCCH associated with a candidate PSSCH resource within the slot, all candidate PSSCH resources on the slot are excluded from a sensed candidate resource set to be reported of a physical layer.

If the number of time-domain symbols overlapping between the idle time position within the channel occupancy period and a candidate PSSCH resource within the slot and the third preset threshold satisfy the second preset relationship, or a time-domain position of a PSFCH transmission is shifted within the slot and a time-domain overlap exists between a shifted time-domain position of the PSFCH transmission and a PSCCH associated with a candidate PSSCH resource within the slot, all candidate PSSCH resources on the slot are excluded from a candidate resource set within a resource selection window of a MAC layer.

A time-domain position of a PSFCH transmission is shifted between slots, and the first availability rule is executed.

The slot is excluded from the resource pool when time-domain resources of the PSFCH are mapped, and the first availability rule is executed.

A PSFCH transmission in the slot is stopped, and the first availability rule is executed.

In an embodiment, the second availability rule is configured by radio resource control (RRC), preconfigured, or predefined.

Principle 3: If an idle time position within the channel occupancy period overlaps in the time domain with both a PSSCH and a PSFCH within a slot of the resource pool, the third availability rule is determined.

Exemplarily, the third availability rule includes at least one of the following:

If a time-domain position of a PSFCH transmission is shifted within the slot, and no time-domain overlap exists between a shifted time-domain position of the PSFCH transmission and a PSCCH associated with a PSSCH at a determined resource position within the slot, and the number of available PSSCH symbols remaining in the slot after the shift and a second preset threshold satisfy a second preset relationship, the remaining PSSCH symbols in the slot are allowed to be used for puncturing transmission or rate-matching transmission.

If a time-domain position of a PSFCH transmission is shifted within the slot, and the number of available PSSCH symbols remaining in the slot after the shift and the second preset threshold satisfy the second preset relationship, the remaining PSSCH symbols in the slot are allowed to be used for puncturing transmission or rate-matching transmission.

If a time-domain position of a PSFCH transmission is shifted within the slot, and a time-domain overlap exists between a shifted time-domain position of the PSFCH transmission and a PSCCH associated with a PSSCH at a determined resource position within the slot, or the number of available PSSCH symbols remaining in the slot after the shift and the second preset threshold satisfy a first preset relationship, the PSSCH transmission within the slot is dropped.

If a time-domain position of a PSFCH transmission is shifted within the slot, and a time-domain overlap exists between a shifted time-domain position of the PSFCH transmission and a PSCCH associated with a candidate PSSCH resource within the slot, or the number of available symbols of a candidate PSSCH resource remaining in the slot after the shift and the second preset threshold satisfy the first preset relationship, all candidate PSSCH resources on the slot are excluded from an initial candidate PSSCH resource set of a physical layer.

If a time-domain position of a PSFCH transmission is shifted within the slot, and a time-domain overlap exists between a shifted time-domain position of the PSFCH transmission and a PSCCH associated with a candidate PSSCH resource within the slot, or the number of available symbols of a candidate PSSCH resource remaining in the slot after the shift and the second preset threshold satisfy the first preset relationship, all candidate PSSCH resources on the slot are excluded from a sensed candidate resource set to be reported of the physical layer.

If a time-domain position of a PSFCH transmission is shifted within the slot, and a time-domain overlap exists between a shifted time-domain position of the PSFCH transmission and a PSCCH associated with a candidate PSSCH resource within the slot, or the number of available symbols of a candidate PSSCH resource remaining in the slot after the shift and the second preset threshold satisfy the first preset relationship, all candidate PSSCH resources on the slot are excluded from a candidate resource set within a resource selection window of a MAC layer.

If a time-domain position of a PSFCH transmission is shifted within the slot, and a time-domain overlap exists between a shifted time-domain position of the PSFCH transmission and a PSCCH associated with a PSSCH at a determined resource position within the slot, or the number of available PSSCH symbols remaining in the slot after the shift and the second preset threshold satisfy the first preset relationship, resource reselection in a higher-layer of a device is triggered.

If a time-domain position of a PSFCH transmission is shifted within the slot, and a time-domain overlap exists between a shifted time-domain position of the PSFCH transmission and a PSCCH associated with a PSSCH at a determined resource position within the slot, or the number of available PSSCH symbols remaining in the slot after the shift and the second preset threshold satisfy the first preset relationship, a device is triggered to transmit an SR or a BSR.

If the number of time-domain symbols overlapping between the idle time position within the channel occupancy period and a PSSCH at a determined resource position within the slot and a third preset threshold satisfy the first preset relationship, and a time-domain position of a PSFCH transmission is shifted within the slot, the PSSCH within the slot is allowed to be used for puncturing transmission or rate-matching transmission.

If the number of time-domain symbols overlapping between the idle time position within the channel occupancy period and a PSSCH at a determined resource position within the slot and the third preset threshold satisfy the first preset relationship, and a time-domain position of a PSFCH transmission is shifted within the slot, and no time-domain overlap exists between a shifted time-domain position of the PSFCH transmission and a PSCCH associated with the PSSCH with the determined resource position within the slot, the PSSCH within the slot is allowed to be used for puncturing transmission or rate-matching transmission.

If the number of time-domain symbols overlapping between the idle time position within the channel occupancy period and a PSSCH at a determined resource position within the slot and the third preset threshold satisfy a second preset relationship, or a time-domain position of a PSFCH transmission is shifted within the slot and a time-domain overlap exists between a shifted time-domain position of the PSFCH transmission and a PSCCH associated with a PSSCH at a determined resource position within the slot, the PSSCH transmission within the slot is dropped.

If the number of time-domain symbols overlapping between the idle time position within the channel occupancy period and a PSSCH at a determined resource position within the slot and the third preset threshold satisfy the second preset relationship, or a time-domain position of a PSFCH transmission is shifted within the slot and a time-domain overlap exists between a shifted time-domain position of the PSFCH transmission and a PSCCH associated with a PSSCH at a determined resource position within the slot, resource reselection in a higher-layer of a device is triggered.

If the number of time-domain symbols overlapping between the idle time position within the channel occupancy period and a PSSCH at a determined resource position within the slot and the third preset threshold satisfy the second preset relationship, or a time-domain position of a PSFCH transmission is shifted within the slot and a time-domain overlap exists between a shifted time-domain position of the PSFCH transmission and a PSCCH associated with a PSSCH at a determined resource position within the slot, a device is triggered to transmit an SR or a BSR.

If the number of time-domain symbols overlapping between the idle time position within the channel occupancy period and a candidate PSSCH resource within the slot and the third preset threshold satisfy the second preset relationship, or a time-domain position of a PSFCH transmission is shifted within the slot and a time-domain overlap exists between a shifted time-domain position of the PSFCH transmission and a PSCCH associated with a candidate PSSCH resource within the slot, all candidate PSSCH resources on the slot are excluded from an initial candidate PSSCH resource set of a physical layer.

If the number of time-domain symbols overlapping between the idle time position within the channel occupancy period and a candidate PSSCH resource within the slot and the third preset threshold satisfy the second preset relationship, or a time-domain position of a PSFCH transmission is shifted within the slot and a time-domain overlap exists between a shifted time-domain position of the PSFCH transmission and a PSCCH associated with a candidate PSSCH resource within the slot, all candidate PSSCH resources on the slot are excluded from a sensed candidate resource set to be reported of a physical layer.

If the number of time-domain symbols overlapping between the idle time position within the channel occupancy period and a candidate PSSCH resource within the slot and the third preset threshold satisfy the second preset relationship, or a time-domain position of a PSFCH transmission is shifted within the slot and a time-domain overlap exists between a shifted time-domain position of the PSFCH transmission and a PSCCH associated with a candidate PSSCH resource within the slot, all candidate PSSCH resources on the slot are excluded from a candidate resource set within a resource selection window of a MAC layer.

A time-domain position of a PSFCH transmission is shifted between slots, and the first availability rule is executed.

The slot is excluded from the resource pool when time-domain resources of the PSFCH are mapped, and the first availability rule is executed.

A PSFCH transmission in the slot is stopped, and the first availability rule is executed.

The first availability rule mentioned in the third availability rule is the same as the first availability rule in principle 1 above and is not repeated here for brevity.

In an embodiment, shifting the time-domain position of the PSFCH transmission within the slot as mentioned in principles 2 and 3 above includes the following: The slot includes L symbols, with corresponding symbol indices from S to S+L−1. The index of a symbol with the smallest index among symbols overlapping between the idle time position within the channel occupancy period and the L symbols within the slot of the resource pool is Q, the indices of available symbols within the slot are from S to Q−1, and the last symbol index allowed for the PSFCH transmission within the slot is Q−1.

The number of symbols by which PSFCH symbols are shifted within the slot is P−Q+1, where the index of the second symbol for the PSFCH transmission before the shift is P, and the index of the second symbol for the PSFCH transmission after the shift is Q−1.

The number of symbols by which PSFCH symbols are shifted within the slot is P−Q+1, where the index of the second symbol for the PSFCH transmission before the shift is P, and the index of the second symbol for the PSFCH transmission after the shift is S+1.

The number of symbols by which PSFCH symbols are shifted within the slot is P−Q+1, where the index of the second symbol for the PSFCH transmission before the shift is P, and the index of the second symbol for the PSFCH transmission after the shift is between S+1 and Q−1.

If Q−S is greater than or equal to a fourth preset threshold, the number of symbols by which PSFCH symbols are shifted within the slot is P−Q+1, where the index of the second symbol for the PSFCH transmission before the shift is P, and the index of the second symbol for the PSFCH transmission after the shift is Q−1.

If Q−S is greater than or equal to the fourth preset threshold, the number of symbols by which PSFCH symbols are shifted within the slot is P−Q+1, where the index of the second symbol for the PSFCH transmission before the shift is P, and the index of the second symbol for the PSFCH transmission after the shift is S+1.

If Q−S is greater than or equal to the fourth preset threshold, the number of symbols by which PSFCH symbols are shifted within the slot is P−Q+1, where the index of the second symbol for the PSFCH transmission before the shift is P, and the index of the second symbol for the PSFCH transmission after the shift is between S+1 and Q−1. For example, the index of the second symbol for the PSFCH transmission after the shift is S+2, S+3, or S+4.

If Q−S is less than the fourth preset threshold, the time-domain position of the PSFCH transmission is shifted between slots, the slot is excluded from the resource pool when time-domain resources of the PSFCH are mapped, or the PSFCH transmission in the slot is stopped, according to a configuration, a preconfiguration, or a predefinition.

$$L \geq 1 , S \geq 0 , Q \geq S , and Q \leq S + L - 1.$$

$$In an embodiment , Q > S + 1 ; or Q > S + 2 .$$

In an embodiment, after shifting the time-domain position of the PSFCH transmission between slots as mentioned in principles 2 and 3 above, the time-domain position of the PSFCH transmission is the index symbol for the PSFCH transmission before the shift plus 12 or 14, or the time-domain position of the PSFCH transmission is the index symbol for the PSFCH transmission before the shift minus 12 or 14.

In an embodiment, puncturing transmission refers to mapping resources within a slot on a physical layer without considering the impact of the idle period (that is, the idle time within the channel occupancy period), where after mapping, if it is determined that some symbols mapped with SL data within the slot overlap with the idle period in the time domain, no SL data is transmitted through these overlapping symbols, and the transmitted data may be incomplete.

Rate-matching transmission refers to mapping SL data onto physical resources on the physical layer with taking into account the impact of the idle period, where data mapping may be performed on the remaining symbols obtained by excluding the symbols overlapping the idle period from the symbols in the slot used for mapping SL data, and then the complete data is transmitted.

In operation 2, the resource position and the transmission mode of the channel are determined based on the availability rule.

In S130, data is transmitted at the resource position according to the transmission mode.

In an embodiment, the transmitted data may be a channel or signal (including but not limited to an S-SSB, a PSCCH, a PSSCH, and a PSFCH).

Below are some examples to illustrate the method of determining a resource position and a transmission mode of a channel based on the resource pool configuration information and the semi-static channel occupancy information.

### Example One

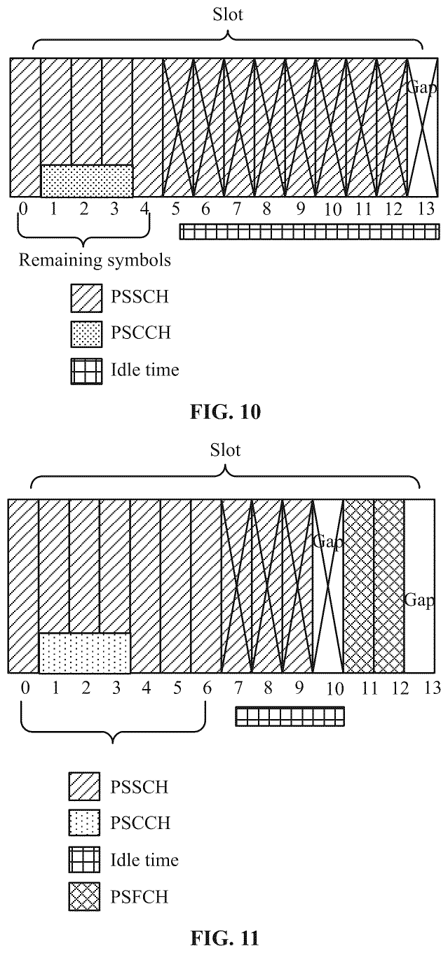

FIG. 9 is a schematic diagram of a first method for determining a resource position and a transmission mode of a channel according to an embodiment. As shown in FIG. 9, the idle time position within the channel occupancy period overlaps with the PSSCH within a slot of the resource pool by 3 symbols, and the number of remaining PSSCH symbols in the slot is 10.

Assuming the first preset threshold is 4, the number of overlapping symbols (that is, 3) between the idle time position within the channel occupancy period and the PSSCH within the slot of the resource pool and the first preset threshold (that is, 4) satisfy the first preset relationship, that is, 3 is less than 4. Then, the PSSCH scheduled in this slot performs puncturing transmission on the 3 overlapping symbols when the slot is transmitted.

Similarly, assuming the second preset threshold is 8, the number of remaining PSSCH symbols in the slot (that is, 10) and the second preset threshold (that is, 8) satisfy the second preset relationship, that is, 10 is greater than 8. Then, the PSSCH scheduled in this slot performs puncturing transmission on the 3 overlapping symbols when the slot is transmitted.

### Example Two

FIG. 10 is a schematic diagram of a second method for determining a resource position and transmission mode of a channel according to an embodiment. As shown in FIG. 10, the idle time position within the channel occupancy period overlaps with the PSSCH within a slot of the resource pool by 8 symbols, and the number of remaining PSSCH symbols in the slot is 5.

Assuming the first preset threshold is 4, the number of overlapping symbols (that is, 8) between the idle time position within the channel occupancy period and the PSSCH within the slot of the resource pool and the first preset threshold (that is, 4) satisfy the second preset relationship, that is, 8 is greater than 4. Then, the PSSCH scheduled in this slot is dropped when the slot is transmitted.

Similarly, assuming the second preset threshold is 8, the number of remaining PSSCH symbols in the slot (that is, 5) and the second preset threshold (that is, 8) satisfy the first preset relationship, that is, 5 is less than 8. Then, the PSSCH scheduled in this slot is dropped when the slot is transmitted.

### Example Three

FIG. 11 is a schematic diagram of a third method for determining a resource position and transmission mode of a channel according to an embodiment. As shown in FIG. 11, the idle time position within the channel occupancy period overlaps with the PSSCH within a slot of the resource pool by 3 symbols, and the number of remaining PSSCH symbols in the slot is 7.

Assuming the first preset threshold is 4, the number of overlapping symbols (that is, 3) between the idle time position within the channel occupancy period and the PSSCH within the slot of the resource pool and the first preset threshold (that is, 4) satisfy the first preset relationship, that is, 3 is less than 4. Then, the PSSCH scheduled in this slot performs puncturing transmission on the 3 overlapping symbols when the slot is transmitted, and the PSFCH resources within the slot are not affected.

### Example Four

When the idle time position within the channel occupancy period overlaps in the time domain with the second symbol of PSFCH transmission within a slot of the resource pool and does not overlap in the time domain with the first symbol of PSFCH transmission, the entire time-domain position of PSFCH transmission is shifted within the slot by 1 symbol (for example, shifted left by 1 symbol). At this time, the index of the second symbol of PSFCH transmission is startSLsymbols+lengthSLsymbols−2−1.

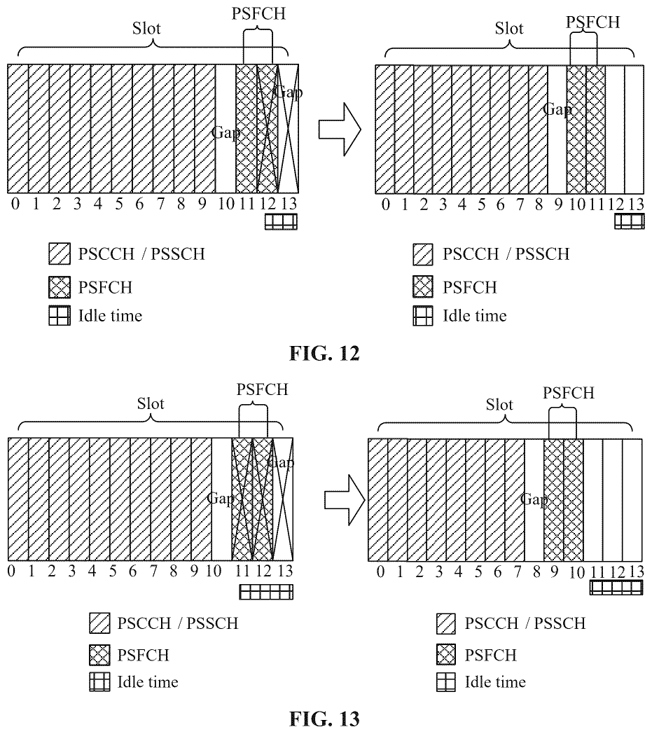

FIG. 12 is a schematic diagram of a fourth method for determining a resource position and a transmission mode of a channel according to an embodiment. As shown in FIG. 12, the idle time position within the channel occupancy period overlaps in the time domain with the second symbol of PSFCH transmission within a slot of the resource pool and the last symbol of the slot, where startSLsymbols=0 and lengthSLsymbols=14. To ensure the PSFCH is not affected, all symbols of PSFCH transmission are shifted left by one symbol within the slot, and the index of the second symbol of PSFCH transmission is updated from 12 to 11.

### Example Five

When the idle time position within the channel occupancy period overlaps in the time domain with the first symbol of PSFCH transmission within a slot of the resource pool and does not overlap in the time domain with the PSSCH or the gap symbol between the PSSCH and the PSFCH, the entire time-domain position of PSFCH transmission is shifted within the slot by 2 symbols (for example, shifted left by 2 symbols). At this time, the index of the second symbol of PSFCH transmission is startSLsymbols+lengthSLsymbols−2−2.

FIG. 13 is a schematic diagram of a fifth method for determining a resource position and transmission mode of a channel according to an embodiment. As shown in FIG. 13, the idle time position within the channel occupancy period overlaps in the time domain with the first symbol, second symbol, and last symbol of PSFCH transmission within a slot of the resource pool, where startSLsymbols=0 and lengthSLsymbols=14. To ensure the PSFCH is not affected, all symbols of PSFCH transmission are shifted left by two symbols within the slot, and the index of the second symbol of PSFCH transmission is updated from 12 to 10.

### Example Six

When the idle time position within the channel occupancy period overlaps in the time domain with the first symbol of PSFCH transmission within a slot of the resource pool and the gap symbol between the PSSCH and the PSFCH, and does not overlap in the time domain with PSSCH symbols, the entire time-domain position of PSFCH transmission is shifted within the slot by 3 symbols (for example, shifted left by 3 symbols). At this time, the index of the second symbol of PSFCH transmission is startSLsymbols+lengthSLsymbols−2−3.

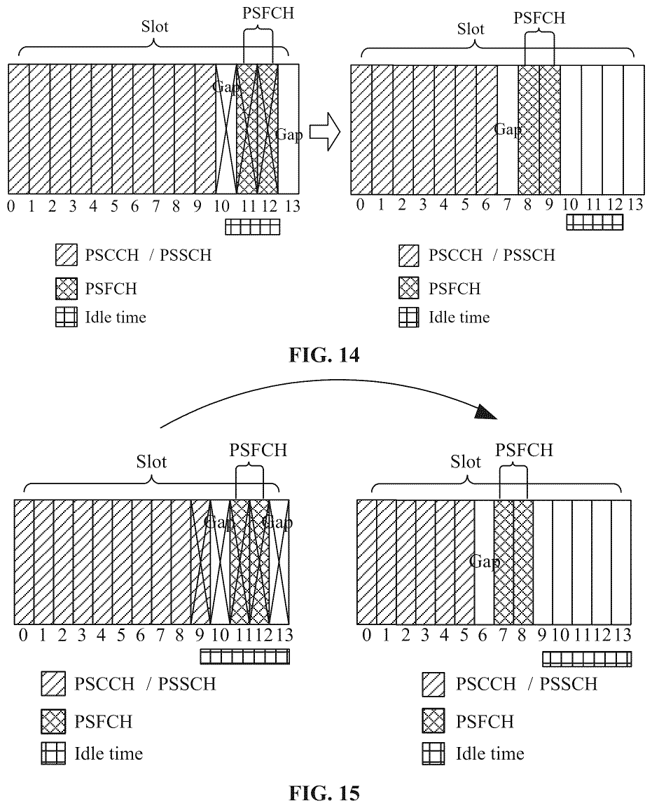

FIG. 14 is a schematic diagram of a sixth method for determining a resource position and transmission mode of a channel according to an embodiment. As shown in FIG. 14, the idle time position within the channel occupancy period overlaps in the time domain with the first symbol, second symbol, and gap symbol between the PSSCH and the PSFCH within a slot of the resource pool, totaling three symbols, where startSLsymbols=0 and lengthSLsymbols=14. To ensure the PSFCH is not affected, all symbols of PSFCH transmission are shifted left by three symbols within the slot, and the index of the second symbol of PSFCH transmission is updated from 12 to 9.

### Example Seven

FIG. 15 is a schematic diagram of a seventh method for determining a resource position and a transmission mode of a channel according to an embodiment. As shown in FIG. 15, the idle time position within the channel occupancy period overlaps in the time domain with the last 5 symbols within a slot of the resource pool, where startSLsymbols=0 and lengthSLsymbols=14, and the number of overlapping symbols, M, between the idle time position within the channel occupancy period and the PSCCH/PSSCH within the slot is 1. To ensure the PSFCH is not affected, all symbols of PSFCH transmission are shifted left by 4 symbols within the slot, and the index of the second symbol of PSFCH transmission is updated from 12 to 8.

### Example Eight

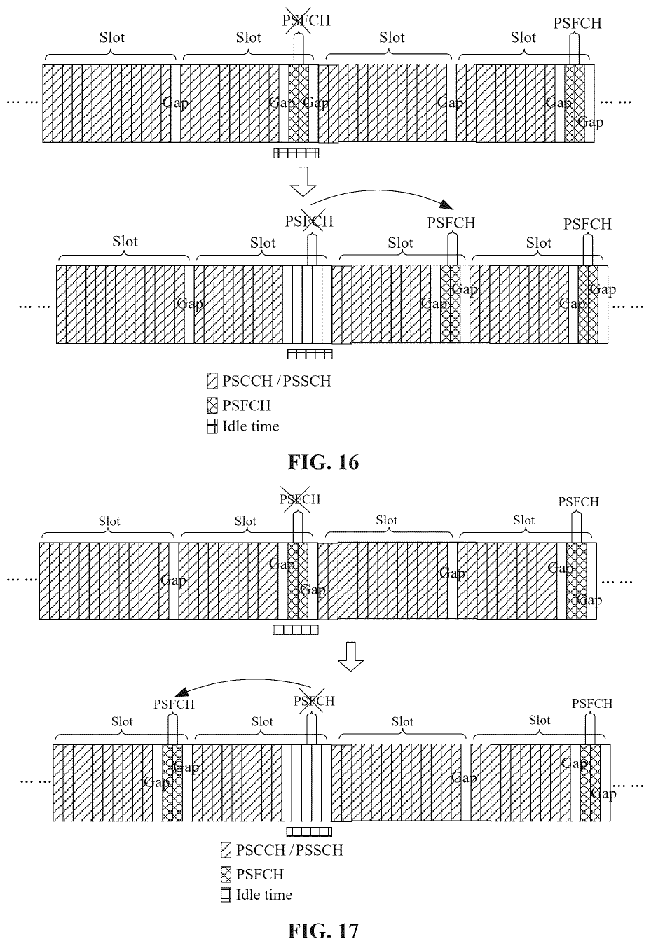

FIG. 16 is a schematic diagram of an eighth method for determining a resource position and transmission mode of a channel according to an embodiment. As shown in FIG. 16, when the idle time position within the channel occupancy period overlaps in the time domain with the PSFCH within a slot of the resource pool and the PSFCH period is greater than 1 slot, the PSFCH resource on the current slot is disabled, and a corresponding PSFCH resource is set on the slot with the index of the current slot plus 1 within the resource pool.

Alternatively, FIG. 17 is a schematic diagram of a ninth method for determining a resource position and transmission mode of a channel according to an embodiment. As shown in FIG. 17, when the idle time position within the channel occupancy period overlaps in the time domain with the PSFCH within a slot of the resource pool and the PSFCH period is greater than 1 slot, the PSFCH resource on the current slot is disabled, and a corresponding PSFCH resource is set on the slot with the index of the current slot minus 1 within the resource pool.

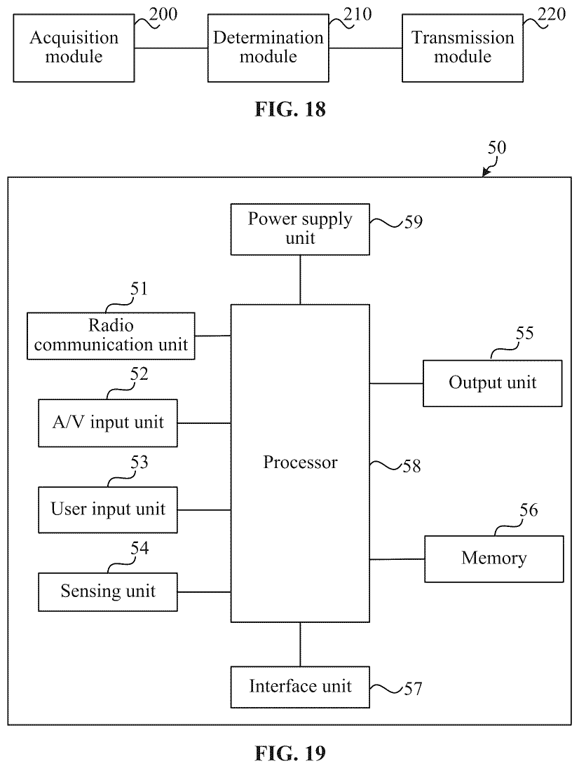

FIG. 18 is a diagram illustrating the structure of a data transmission apparatus according to an embodiment. The apparatus may be configured in a communication node. As shown in FIG. 18, the apparatus includes an acquisition module 200, a determination module 210, and a transmission module 220.

The acquisition module 200 is configured to acquire resource pool configuration information and semi-static channel occupancy information.

The determination module 210 is configured to determine a resource position and a transmission mode of a channel based on the resource pool configuration information and the semi-static channel occupancy information, where the channel is a data channel or a feedback channel.

The transmission module 220 is configured to transmit data at the resource position according to the transmission mode.

The data transmission apparatus provided by the embodiment is used to implement the data transmission method of the above embodiments. The implementation principles and technical effects of the data transmission apparatus provided by this embodiment are similar to those of the above embodiments and are not repeated here.

In an embodiment, the resource pool configuration information includes at least one of the following: a time-domain resource configuration parameter of an SL resource pool, a frequency-domain subband resource configuration parameter of an SL resource pool, a control channel configuration parameter of an SL resource pool, a data channel configuration parameter of an SL resource pool, a feedback channel configuration parameter of an SL resource pool, or a configuration parameter of a symbol within a slot of an SL resource pool.

In an embodiment, the semi-static channel occupancy information includes at least one of the following: a channel occupancy period, a first offset offset1 of a channel occupancy period, information about a trigger signal within a channel occupancy period, or information about an idle time within a channel occupancy period.

In an embodiment, the information about the trigger signal within the channel occupancy period includes at least one of a time-domain position of the trigger signal or a time-domain length of the trigger signal.

In an embodiment, the starting position of the trigger signal is the sum of the starting position of the channel occupancy period and a second offset offset2 of the trigger signal.

In an embodiment, the time-domain length of the trigger signal is N symbols, where N is a positive integer.

In an embodiment, the information about the idle time within the channel occupancy period includes at least one of a time-domain position of the idle time or a time-domain length of the idle time.

In an embodiment, the ending position of the idle time is the sum of the ending position of the channel occupancy period and a third offset offset3 of the idle time; alternatively, the starting position of the idle time is the sum of the ending position of the channel occupancy period and a third offset offset3 of the idle time; alternatively, the starting position of the idle time is the sum of the starting position of the channel occupancy period and a third offset offset3 of the idle time; alternatively, the time-domain position of the idle time is a predefined time-domain position.

In an embodiment, the semi-static channel occupancy information includes at least one of the following: a frequency-domain resource position of a trigger signal within a channel occupancy period, or a format of a trigger signal within a channel occupancy period.

In an embodiment, the frequency-domain resource position of the trigger signal is a group of consecutive physical resource blocks (PRBs) within a configured, preconfigured, or predefined resource block set (RB set), a group of discrete PRBs within a configured, preconfigured, or predefined RB set, all PRBs on an interlace within a configured, preconfigured, or predefined RB set, or part of PRBs on an interlace within a configured, preconfigured, or predefined RB set; and the format of the trigger signal includes a physical sidelink control channel (PSCCH), a physical sidelink shared channel (PSSCH), a physical sidelink feedback channel (PSFCH), a channel state information-reference signal (CSI-RS), a sidelink synchronization signal block (S-SSB), a predefined sequence, and a cyclic prefix extension (CPE).

In an embodiment, the frequency-domain resource position of the trigger signal is orthogonal to a frequency-domain resource of a PSFCH; the frequency-domain resource position of the trigger signal is orthogonal to a frequency-domain resource of an S-SSB.

In an embodiment, if the time-domain position of the trigger signal overlaps with a time-domain resource position of the data, the trigger signal is not transmitted at an overlapping time-domain resource position.

In an embodiment, the determination module 210 is configured to determine an availability rule of the channel based on the resource pool configuration information and the semi-static channel occupancy information; and determine the resource position and the transmission mode of the channel based on the availability rule.

In an embodiment, the semi-static channel occupancy information includes a channel occupancy period and a first offset offset1 of a channel occupancy period, and the availability rule includes a first availability rule, a second availability rule, and a third availability rule.

The determination module 210 is configured to determine the first availability rule if an idle time position within the channel occupancy period overlaps in the time domain only with a PSSCH within a slot of a resource pool; determine the second availability rule or the third availability rule if an idle time position within the channel occupancy period overlaps in the time domain only with a PSFCH within a slot of a resource pool; or determine the third availability rule if an idle time position within the channel occupancy period overlaps in the time domain with both a PSSCH and a PSFCH within a slot of a resource pool.

In an embodiment, the first availability rule includes at least one of the following:

If the number of time-domain symbols overlapping between the idle time position within the channel occupancy period and a PSSCH at a determined resource position within the slot and a first preset threshold satisfy a first preset relationship, the PSSCH within the slot is allowed to be used for puncturing transmission or rate-matching transmission.

If the number of time-domain symbols overlapping between the idle time position within the channel occupancy period and a PSSCH at a determined resource position within the slot and the first preset threshold satisfy the first preset relationship, and no time-domain overlap exists between the idle time position within the channel occupancy period and a PSCCH associated with the PSSCH with the determined resource position within the slot, the PSSCH within the slot is allowed to be used for puncturing transmission or rate-matching transmission.

If the number of time-domain symbols overlapping between the idle time position within the channel occupancy period and a PSSCH at a determined resource position within the slot and the first preset threshold satisfy a second preset relationship, or a time-domain overlap exists between the idle time position within the channel occupancy period and a PSCCH associated with a PSSCH at a determined resource position within the slot, the PSSCH transmission within the slot is dropped.

If the number of time-domain symbols overlapping between the idle time position within the channel occupancy period and a PSSCH at a determined resource position within the slot and the first preset threshold satisfy the second preset relationship, or a time-domain overlap exists between the idle time position within the channel occupancy period and a PSCCH associated with a PSSCH at a determined resource position within the slot, resource reselection in a higher-layer of a device is triggered.

If the number of time-domain symbols overlapping between the idle time position within the channel occupancy period and a PSSCH at a determined resource position within the slot and the first preset threshold satisfy the second preset relationship, or a time-domain overlap exists between the idle time position within the channel occupancy period and a PSCCH associated with a PSSCH at a determined resource position within the slot, a device is triggered to transmit a scheduling request (SR) or a buffer status report (BSR).

If the number of time-domain symbols overlapping between the idle time position within the channel occupancy period and a candidate PSSCH resource within the slot and the first preset threshold satisfy the second preset relationship, or a time-domain overlap exists between the idle time position within the channel occupancy period and a PSCCH resource associated with a candidate PSSCH resource within the slot, all candidate PSSCH resources on the slot are excluded from an initial candidate PSSCH resource set of a physical layer.

If the number of time-domain symbols overlapping between the idle time position within the channel occupancy period and a candidate PSSCH resource within the slot and the first preset threshold satisfy the second preset relationship, or a time-domain overlap exists between the idle time position within the channel occupancy period and a PSCCH resource associated with a candidate PSSCH resource within the slot, all candidate PSSCH resources on the slot are excluded from a sensed candidate resource set to be reported of the physical layer.

If the number of time-domain symbols overlapping between the idle time position within the channel occupancy period and a candidate PSSCH resource within the slot and the first preset threshold satisfy the second preset relationship, or a time-domain overlap exists between the idle time position within the channel occupancy period and a PSCCH resource associated with a candidate PSSCH resource within the slot, all candidate PSSCH resources on the slot are excluded from a candidate resource set within a resource selection window of a medium access control (MAC) layer.

If the number of available PSSCH symbols, which remain in the slot and exclude symbols overlapping between the idle time position within the channel occupancy period and a PSSCH at a determined resource position within the slot, and a second preset threshold satisfy the second preset relationship, the PSSCH within the slot is allowed to be used for puncturing transmission or rate-matching transmission.

If the number of available PSSCH symbols, which remain in the slot and exclude symbols overlapping between the idle time position within the channel occupancy period and a PSSCH at a determined resource position within the slot, and the second preset threshold satisfy the second preset relationship, and no time-domain overlap exists between the idle time position within the channel occupancy period and a PSCCH associated with the PSSCH with the determined resource position within the slot, the PSSCH within the slot is allowed to be used for puncturing transmission or rate-matching transmission.

If the number of available PSSCH symbols, which remain in the slot and exclude symbols overlapping between the idle time position within the channel occupancy period and a PSSCH at a determined resource position within the slot, and the second preset threshold satisfy the first preset relationship, or a time-domain overlap exists between the idle time position within the channel occupancy period and a PSCCH associated with a PSSCH at a determined resource position within the slot, the PSSCH transmission within the slot is dropped.

If the number of available PSSCH symbols, which remain in the slot and exclude symbols overlapping between the idle time position within the channel occupancy period and a PSSCH at a determined resource position within the slot, and the second preset threshold satisfy the first preset relationship, or a time-domain overlap exists between the idle time position within the channel occupancy period and a PSCCH associated with a PSSCH at a determined resource position within the slot, resource reselection in a higher-layer of a device is triggered.

If the number of available PSSCH symbols, which remain in the slot and exclude symbols overlapping between the idle time position within the channel occupancy period and a PSSCH at a determined resource position within the slot, and the second preset threshold satisfy the first preset relationship, or a time-domain overlap exists between the idle time position within the channel occupancy period and a PSCCH associated with a PSSCH at a determined resource position within the slot, a device is triggered to transmit an SR or a BSR.

If the number of available PSSCH symbols, which remain in the slot and exclude symbols overlapping between the idle time position within the channel occupancy period and a PSSCH at a determined resource position within the slot, and the second preset threshold satisfy the first preset relationship, or a time-domain overlap exists between the idle time position within the channel occupancy period and a PSCCH resource associated with a candidate PSSCH resource within the slot, all candidate PSSCH resources on the slot are excluded from an initial candidate PSSCH resource set of a physical layer.

If the number of available PSSCH symbols, which remain in the slot and exclude symbols overlapping between the idle time position within the channel occupancy period and a PSSCH at a determined resource position within the slot, and the second preset threshold satisfy the first preset relationship, or a time-domain overlap exists between the idle time position within the channel occupancy period and a PSCCH resource associated with a candidate PSSCH resource within the slot, all candidate PSSCH resources on the slot are excluded from a sensed candidate resource set to be reported of the physical layer.

If the number of available PSSCH symbols, which remain in the slot and exclude symbols overlapping between the idle time position within the channel occupancy period and a PSSCH at a determined resource position within the slot, and the second preset threshold satisfy the first preset relationship, or a time-domain overlap exists between the idle time position within the channel occupancy period and a PSCCH resource associated with a candidate PSSCH resource within the slot, all candidate PSSCH resources on the slot are excluded from a candidate resource set within a resource selection window of a MAC layer.

In an embodiment, the second availability rule includes at least one of the following: A time-domain position of a PSFCH transmission is shifted within the slot.

A time-domain position of a PSFCH transmission is shifted between slots.

The slot is excluded from the resource pool when time-domain resources of the PSFCH are mapped.

A PSFCH transmission in the slot is stopped.

In an embodiment, the second availability rule is configured by radio resource control (RRC), preconfigured, or predefined.

In an embodiment, the third availability rule includes at least one of the following:

If a time-domain position of a PSFCH transmission is shifted within the slot, and no time-domain overlap exists between a shifted time-domain position of the PSFCH transmission and a PSCCH associated with a PSSCH at a determined resource position within the slot, and the number of available PSSCH symbols remaining in the slot after the shift and a second preset threshold satisfy a second preset relationship, the remaining PSSCH symbols in the slot are allowed to be used for puncturing transmission or rate-matching transmission.

If a time-domain position of a PSFCH transmission is shifted within the slot, and the number of available PSSCH symbols remaining in the slot after the shift and the second preset threshold satisfy the second preset relationship, the remaining PSSCH symbols in the slot are allowed to be used for puncturing transmission or rate-matching transmission.

If a time-domain position of a PSFCH transmission is shifted within the slot, and a time-domain overlap exists between a shifted time-domain position of the PSFCH transmission and a PSCCH associated with a PSSCH at a determined resource position within the slot, or the number of available PSSCH symbols remaining in the slot after the shift and the second preset threshold satisfy a first preset relationship, the PSSCH transmission within the slot is dropped.

If a time-domain position of a PSFCH transmission is shifted within the slot, and a time-domain overlap exists between a shifted time-domain position of the PSFCH transmission and a PSCCH associated with a candidate PSSCH resource within the slot, or the number of available symbols of a candidate PSSCH resource remaining in the slot after the shift and the second preset threshold satisfy the first preset relationship, all candidate PSSCH resources on the slot are excluded from an initial candidate PSSCH resource set of a physical layer.

If a time-domain position of a PSFCH transmission is shifted within the slot, and a time-domain overlap exists between a shifted time-domain position of the PSFCH transmission and a PSCCH associated with a candidate PSSCH resource within the slot, or the number of available symbols of a candidate PSSCH resource remaining in the slot after the shift and the second preset threshold satisfy the first preset relationship, all candidate PSSCH resources on the slot are excluded from a sensed candidate resource set to be reported of the physical layer.

If a time-domain position of a PSFCH transmission is shifted within the slot, and a time-domain overlap exists between a shifted time-domain position of the PSFCH transmission and a PSCCH associated with a candidate PSSCH resource within the slot, or the number of available symbols of a candidate PSSCH resource remaining in the slot after the shift and the second preset threshold satisfy the first preset relationship, all candidate PSSCH resources on the slot are excluded from a candidate resource set within a resource selection window of a MAC layer.

If a time-domain position of a PSFCH transmission is shifted within the slot, and a time-domain overlap exists between a shifted time-domain position of the PSFCH transmission and a PSCCH associated with a PSSCH at a determined resource position within the slot, or the number of available PSSCH symbols remaining in the slot after the shift and the second preset threshold satisfy the first preset relationship, resource reselection in a higher-layer of a device is triggered.

If a time-domain position of a PSFCH transmission is shifted within the slot, and a time-domain overlap exists between a shifted time-domain position of the PSFCH transmission and a PSCCH associated with a PSSCH at a determined resource position within the slot, or the number of available PSSCH symbols remaining in the slot after the shift and the second preset threshold satisfy the first preset relationship, a device is triggered to transmit an SR or a BSR.

If the number of time-domain symbols overlapping between the idle time position within the channel occupancy period and a PSSCH at a determined resource position within the slot and a third preset threshold satisfy the first preset relationship, and a time-domain position of a PSFCH transmission is shifted within the slot, the PSSCH within the slot is allowed to be used for puncturing transmission or rate-matching transmission.

If the number of time-domain symbols overlapping between the idle time position within the channel occupancy period and a PSSCH at a determined resource position within the slot and the third preset threshold satisfy the first preset relationship, and a time-domain position of a PSFCH transmission is shifted within the slot, and no time-domain overlap exists between a shifted time-domain position of the PSFCH transmission and a PSCCH associated with the PSSCH with the determined resource position within the slot, the PSSCH within the slot is allowed to be used for puncturing transmission or rate-matching transmission.

If the number of time-domain symbols overlapping between the idle time position within the channel occupancy period and a PSSCH at a determined resource position within the slot and the third preset threshold satisfy a second preset relationship, or a time-domain position of a PSFCH transmission is shifted within the slot and a time-domain overlap exists between a shifted time-domain position of the PSFCH transmission and a PSCCH associated with a PSSCH at a determined resource position within the slot, the PSSCH transmission within the slot is dropped.

If the number of time-domain symbols overlapping between the idle time position within the channel occupancy period and a PSSCH at a determined resource position within the slot and the third preset threshold satisfy the second preset relationship, or a time-domain position of a PSFCH transmission is shifted within the slot and a time-domain overlap exists between a shifted time-domain position of the PSFCH transmission and a PSCCH associated with a PSSCH at a determined resource position within the slot, resource reselection in a higher-layer of a device is triggered.

If the number of time-domain symbols overlapping between the idle time position within the channel occupancy period and a PSSCH at a determined resource position within the slot and the third preset threshold satisfy the second preset relationship, or a time-domain position of a PSFCH transmission is shifted within the slot and a time-domain overlap exists between a shifted time-domain position of the PSFCH transmission and a PSCCH associated with a PSSCH at a determined resource position within the slot, a device is triggered to transmit an SR or a BSR.

If the number of time-domain symbols overlapping between the idle time position within the channel occupancy period and a candidate PSSCH resource within the slot and the third preset threshold satisfy the second preset relationship, or a time-domain position of a PSFCH transmission is shifted within the slot and a time-domain overlap exists between a shifted time-domain position of the PSFCH transmission and a PSCCH associated with a candidate PSSCH resource within the slot, all candidate PSSCH resources on the slot are excluded from an initial candidate PSSCH resource set of a physical layer.

If the number of time-domain symbols overlapping between the idle time position within the channel occupancy period and a candidate PSSCH resource within the slot and the third preset threshold satisfy the second preset relationship, or a time-domain position of a PSFCH transmission is shifted within the slot and a time-domain overlap exists between a shifted time-domain position of the PSFCH transmission and a PSCCH associated with a candidate PSSCH resource within the slot, all candidate PSSCH resources on the slot are excluded from a sensed candidate resource set to be reported of a physical layer.

If the number of time-domain symbols overlapping between the idle time position within the channel occupancy period and a candidate PSSCH resource within the slot and the third preset threshold satisfy the second preset relationship, or a time-domain position of a PSFCH transmission is shifted within the slot and a time-domain overlap exists between a shifted time-domain position of the PSFCH transmission and a PSCCH associated with a candidate PSSCH resource within the slot, all candidate PSSCH resources on the slot are excluded from a candidate resource set within a resource selection window of a MAC layer.

A time-domain position of a PSFCH transmission is shifted between slots, and the first availability rule is executed.

The slot is excluded from the resource pool when time-domain resources of the PSFCH are mapped, and the first availability rule is executed.

A PSFCH transmission in the slot is stopped, and the first availability rule is executed.

In an embodiment, shifting the time-domain position of the PSFCH transmission within the slot includes the following:

The slot includes L symbols, with corresponding symbol indices from S to S+L−1. The index of a symbol with the smallest index among symbols overlapping between the idle time position within the channel occupancy period and the L symbols within the slot of the resource pool is Q, the indices of available symbols within the slot are from S to Q−1, and the last symbol index allowed for the PSFCH transmission within the slot is Q−1.

The number of symbols by which PSFCH symbols are shifted within the slot is P−Q+1, where the index of the second symbol for the PSFCH transmission before the shift is P, and the index of the second symbol for the PSFCH transmission after the shift is Q−1.

The number of symbols by which PSFCH symbols are shifted within the slot is P−Q+1, where the index of the second symbol for the PSFCH transmission before the shift is P, and the index of the second symbol for the PSFCH transmission after the shift is S+1.

The number of symbols by which PSFCH symbols are shifted within the slot is P−Q+1, where the index of the second symbol for the PSFCH transmission before the shift is P, and the index of the second symbol for the PSFCH transmission after the shift is between S+1 and Q−1.

If Q−S is greater than or equal to a fourth preset threshold, the number of symbols by which PSFCH symbols are shifted within the slot is P−Q+1, where the index of the second symbol for the PSFCH transmission before the shift is P, and the index of the second symbol for the PSFCH transmission after the shift is Q−1.

If Q−S is greater than or equal to the fourth preset threshold, the number of symbols by which PSFCH symbols are shifted within the slot is P−Q+1, where the index of the second symbol for the PSFCH transmission before the shift is P, and the index of the second symbol for the PSFCH transmission after the shift is S+1.

If Q−S is greater than or equal to the fourth preset threshold, the number of symbols by which PSFCH symbols are shifted within the slot is P−Q+1, where the index of the second symbol for the PSFCH transmission before the shift is P, and the index of the second symbol for the PSFCH transmission after the shift is between S+1 and Q−1.

If Q−S is less than the fourth preset threshold, the time-domain position of the PSFCH transmission is shifted between slots, the slot is excluded from the resource pool when time-domain resources of the PSFCH are mapped, or the PSFCH transmission in the slot is stopped, according to a configuration, a preconfiguration, or a predefinition.

In an embodiment, after shifting the time-domain position of the PSFCH transmission between slots, the time-domain position of the PSFCH transmission is the index symbol for the PSFCH transmission before the shift plus 12 or 14, or the time-domain position of the PSFCH transmission is the index symbol for the PSFCH transmission before the shift minus 12 or 14.

Embodiments of the present application also provide a communication node. The communication node includes a processor, which is configured to, when executing a computer program, perform the method provided in any embodiment of the present application. Specifically, the communication node may be the user equipment provided by any embodiment of the present application, and the present application does not impose specific limitations on the communication node.

Exemplarily, the following embodiments provide schematic structural diagrams of a communication node as a UE and as a base station (or higher-layer entity), respectively.

FIG. 19 is a diagram illustrating the structure of a UE according to an embodiment. The UE may be implemented in multiple forms. The UE in the present application may include but is not limited to, mobile terminal devices such as a mobile phone, a smart phone, a notebook computer, a digital broadcast receiver, a personal digital assistant (PDA), a portable device (PAD), a portable multimedia player (PMP), a navigation apparatus, a vehicle-mounted terminal device, a vehicle-mounted display terminal, and a vehicle-mounted electronic rearview mirror and fixed terminal devices such as a digital television (TV) and a desktop computer.

As shown in FIG. 19, a UE 50 may include a radio communication unit 51, an audio/video (A/V) input unit 52, a user input unit 53, a sensing unit 54, an output unit 55, a memory 56, an interface unit 57, a processor 58, and a power supply unit 59. FIG. 19 illustrates the UE including multiple components; but it is to be understood that not all illustrated components are required to be implemented. More or fewer components may be implemented instead.

In this embodiment, the radio communication unit 51 allows radio communication between the UE 50 and another UE, a base station, or a network. The A/V input unit 52 is configured to receive audio or video signals. The user input unit 53 may generate key input data based on commands input by a user to control various operations of the UE 50. The sensing unit 54 detects the current state of the UE 50, the position of the UE 50, the presence or absence of the user's touch input into the UE 50, the orientation of the UE 50, the acceleration or deceleration of the UE 50, the direction of the acceleration or deceleration, and the like and generates commands or signals for controlling the operations of the UE 50. The interface unit 57 serves as an interface through which at least one external apparatus can be connected to the UE 50. The output unit 55 is configured to provide output signals in a visual, audio, and/or tactile manner. The memory 56 may store software programs of processing and control operations executed by the processor 58 and the like or may temporarily store data that has been output or is to be output. The memory 56 may include at least one type of storage medium. Moreover, the UE 50 may cooperate with a network storage apparatus that implements the storage function of the memory 56 through a network connection. The processor 58 is generally configured to control the overall operation of the UE 50. Under the control of the processor 58, the power supply unit 59 receives external power or internal power and provides appropriate power required for operating various elements and components.

The processor 58 executes the programs stored in the memory 56 to perform at least one function application and data processing, for example, to implement the method provided by the embodiments of the present application.

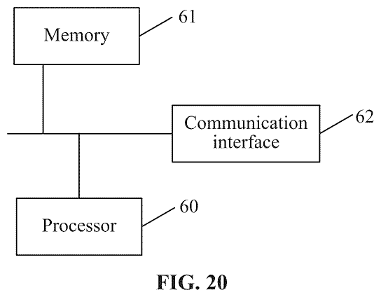

FIG. 20 is a diagram illustrating the structure of a base station (or higher-layer entity) according to an embodiment. As shown in FIG. 20, the base station includes a processor 60, a memory 61, and a communication interface 62. One or more processors 60 may be provided in the base station, and one processor 60 is used as an example in FIG. 20. The processor 60, the memory 61, and the communication interface 62 that are in the base station may be connected through a bus or in other manners. In FIG. 20, the connection through the bus is used as an example. The bus represents one or more of several types of bus structures, including a memory bus or a memory controller, a peripheral bus, an Accelerated Graphics Port (AGP), a processor, or a local bus using any bus structure among multiple bus structures.

As a computer-readable storage medium, the memory 61 may be configured to store software programs, computer-executable programs, and modules, such as program instructions/modules corresponding to the method in the embodiments of the present application. The processor 60 runs the software programs, instructions, and modules stored in the memory 61 to execute at least one of function applications and data processing of the base station, that is, to implement the method described above.

The memory 61 may include a program storage region and a data storage region. The program storage region may store an operating system and an application program required by at least one function. The data storage region may store data created depending on the use of a terminal. Additionally, the memory 61 may include a high-speed random-access memory and may also include a non-volatile memory, for example, at least one magnetic disk memory, a flash memory, or another non-volatile solid-state memory. In some examples, the memory 61 may include memories that are remotely disposed with respect to the processor 60. These remote memories may be connected to the base station via a network. Examples of the preceding network include but are not limited to, the Internet, an intranet, a network, a communication network, and a combination thereof.

The communication interface 62 may be configured to receive and send data.

The embodiments of the present application also provide a computer-readable storage medium. The computer-readable storage medium is configured to store a computer program that, when executed by a processor, implements the method provided by any one of the embodiments of the present application.

The computer storage medium of embodiments of the present application may adopt any combination of one or more computer-readable media. The computer-readable medium may be a computer-readable signal medium or a computer-readable storage medium. The computer-readable storage medium may be, for example, but is not limited to, an electrical, magnetic, optical, electromagnetic, infrared or semiconductor system, apparatus or device, or any combination thereof. The computer readable storage medium includes (a non-exhaustive list) an electrical connection having one or more wires, a portable computer disk, a hard disk, a random access memory (RAM), a read-only memory (ROM), an electrically erasable programmable read only memory (EPROM), a flash memory, an optical fiber, a portable compact disk read-only memory (CD-ROM), an optical memory component, a magnetic memory component, or any suitable combination thereof. In the present application, the computer-readable storage medium may be any tangible medium including or storing a program. The program may be used by or used in conjunction with an instruction execution system, apparatus, or device.

The computer-readable signal medium may include a data signal propagated in a baseband or as part of a carrier. The data signal carries computer-readable program codes. The data signal propagated in this manner may be in multiple forms and includes, but is not limited to, an electromagnetic signal, an optical signal or any suitable combination thereof. The computer-readable signal medium may also be any computer-readable medium other than the computer-readable storage medium. The computer-readable medium may send, propagate, or transmit a program used by or used in conjunction with an instruction execution system, apparatus, or device.

Program codes included on the computer-readable medium may be transmitted by using any suitable medium including, but not limited to, a radio medium, a wire, an optical cable, and radio frequency (RF), or any suitable combination thereof.

Computer program codes for executing the operations of the present disclosure may be written in one or more programming languages or a combination of multiple programming languages. The programming languages include object-oriented programming languages (such as Java, Smalltalk, C++, Ruby and Go) and conventional procedural programming languages (such as “C” or similar programming languages). The program codes may be executed entirely on a user computer, partly on a user computer, as a stand-alone software package, partly on a user computer and partly on a remote computer, or entirely on a remote computer or a server. In the case where the remote computer is involved, the remote computer may be connected to the user computer via any type of network (including a local area network (LAN) or a wide area network (WAN)) or may be connected to an external computer (for example, via the Internet through an Internet service provider).

It is to be understood by those skilled in the art that the term user terminal encompasses any suitable type of wireless user device, for example, a mobile phone, a portable data processing apparatus, a portable web browser, or a vehicle-mounted mobile station.

Generally speaking, various embodiments of the present application may be implemented in hardware or special-purpose circuits, software, logic, or any combination thereof. For example, some aspects may be implemented in hardware while other aspects may be implemented in firmware or software executable by a controller, a microprocessor, or another computing apparatus, though the present application is not limited thereto.

Embodiments of the present application may be implemented through the execution of computer program instructions by a data processor of a mobile apparatus, for example, implemented in a processor entity, by hardware, or by a combination of software and hardware. The computer program instructions may be assembly instructions, instruction set architecture (ISA) instructions, machine instructions, machine-related instructions, microcodes, firmware instructions, state setting data, or source or object codes written in any combination of one or more programming languages.

A block diagram of any logic flow among the drawings of the present application may represent program procedures, may represent interconnected logic circuits, modules, and functions, or may represent a combination of program procedures with logic circuits, modules, and functions. Computer programs may be stored in a memory. The memory may be of any type suitable for a local technical environment and may be implemented by using any suitable data storage technology, such as, but not limited to, a read-only memory (ROM), a random-access memory (RAM), and an optical memory apparatus and system (a digital video disc (DVD) or a compact disk (CD)). The computer-readable medium may include a non-transitory storage medium. The data processor may be of any type suitable to the local technical environment, such as, but is not limited to, a general-purpose computer, a special-purpose computer, a microprocessor, a digital signal processing (DSP), an application specific integrated circuit (ASIC), a field-programmable gate array (FPGA), and a processor based on a multi-core processor architecture.

1. A data transmission method, comprising:
acquiring resource pool configuration information and semi-static channel occupancy information;
determining a resource position and a transmission mode of a channel based on the resource pool configuration information and the semi-static channel occupancy information, wherein the channel is a data channel or a feedback channel; and
transmitting data at the resource position according to the transmission mode.

2. The method according to claim 1, wherein the resource pool configuration information comprises at least one of the following: a time-domain resource configuration parameter of a sidelink (SL) resource pool, a frequency-domain subband resource configuration parameter of an SL resource pool, a control channel configuration parameter of an SL resource pool, a data channel configuration parameter of an SL resource pool, a feedback channel configuration parameter of an SL resource pool, or a configuration parameter of a symbol within a slot of an SL resource pool.

3. The method according to claim 1, wherein the semi-static channel occupancy information comprises at least one of the following: a channel occupancy period, a first offset offset1 of a channel occupancy period, information about a trigger signal within a channel occupancy period, or information about an idle time within a channel occupancy period.

4. The method according to claim 3, wherein the information about the trigger signal within the channel occupancy period comprises at least one of a time-domain position of the trigger signal or a time-domain length of the trigger signal.

5. The method according to claim 4, wherein a starting position of the trigger signal is a sum of a starting position of the channel occupancy period and a second offset offset2 of the trigger signal.

6. (canceled)

7. The method according to claim 3, wherein the information about the idle time within the channel occupancy period comprises at least one of a time-domain position of the idle time or a time-domain length of the idle time.

8. The method according to claim 7, wherein one of the following is satisfied:
an ending position of the idle time is a sum of an ending position of the channel occupancy period and a third offset offset3 of the idle time;
a starting position of the idle time is a sum of an ending position of the channel occupancy period and a third offset offset3 of the idle time;
a starting position of the idle time is a sum of a starting position of the channel occupancy period and a third offset offset3 of the idle time; and
the time-domain position of the idle time is a predefined time-domain position.

9. The method according to claim 1, wherein the semi-static channel occupancy information comprises at least one of the following: a frequency-domain resource position of a trigger signal within a channel occupancy period, or a format of a trigger signal within a channel occupancy period.

10. The method according to claim 9, wherein the frequency-domain resource position of the trigger signal is a group of consecutive physical resource blocks (PRBs) within a configured, preconfigured, or predefined resource block set (RB set), a group of discrete PRBs within a configured, preconfigured, or predefined RB set, all PRBs on an interlace within a configured, preconfigured, or predefined RB set, or part of PRBs on an interlace within a configured, preconfigured, or predefined RB set; and
the format of the trigger signal comprises a physical sidelink control channel (PSCCH), a physical sidelink shared channel (PSSCH), a physical sidelink feedback channel (PSFCH), a channel state information-reference signal (CSI-RS), a sidelink synchronization signal block (S-SSB), a predefined sequence, and a cyclic prefix extension (CPE).

11. (canceled)

12. The method according to claim 4, wherein in a case where the time-domain position of the trigger signal overlaps with a time-domain resource position of the data, the trigger signal is not transmitted at an overlapping time-domain resource position.

13. The method according to claim 1, wherein determining the resource position and the transmission mode of the channel based on the resource pool configuration information and the semi-static channel occupancy information comprises:
determining an availability rule of the channel based on the resource pool configuration information and the semi-static channel occupancy information; and
determining the resource position and the transmission mode of the channel based on the availability rule.

14. The method according to claim 13, wherein the semi-static channel occupancy information comprises a channel occupancy period and a first offset offset1 of a channel occupancy period, and the availability rule comprises a first availability rule, a second availability rule, and a third availability rule; and
determining the availability rule of the channel based on the resource pool configuration information and the semi-static channel occupancy information comprises:
determining the first availability rule in a case where an idle time position within the channel occupancy period overlaps in a time domain only with a PSSCH within a slot of a resource pool;
determining the second availability rule or the third availability rule in a case where an idle time position within the channel occupancy period overlaps in a time domain only with a PSFCH within a slot of a resource pool; or
determining the third availability rule in a case where an idle time position within the channel occupancy period overlaps in a time domain with both a PSSCH and a PSFCH within a slot of a resource pool.

15. The method according to claim 14, wherein the first availability rule comprises at least one of the following:
in a case where a number of time-domain symbols overlapping between the idle time position within the channel occupancy period and a PSSCH at a determined resource position within the slot and a first preset threshold satisfy a first preset relationship, allowing the PSSCH within the slot to be used for puncturing transmission or rate-matching transmission;
in a case where a number of time-domain symbols overlapping between the idle time position within the channel occupancy period and a PSSCH at a determined resource position within the slot and the first preset threshold satisfy the first preset relationship, and no time-domain overlap exists between the idle time position within the channel occupancy period and a PSCCH associated with the PSSCH with the determined resource position within the slot, allowing the PSSCH within the slot to be used for puncturing transmission or rate-matching transmission;
in a case where a number of time-domain symbols overlapping between the idle time position within the channel occupancy period and a PSSCH at a determined resource position within the slot and the first preset threshold satisfy a second preset relationship, or a time-domain overlap exists between the idle time position within the channel occupancy period and a PSCCH associated with a PSSCH at a determined resource position within the slot, dropping PSSCH transmission within the slot;
in a case where a number of time-domain symbols overlapping between the idle time position within the channel occupancy period and a PSSCH at a determined resource position within the slot and the first preset threshold satisfy the second preset relationship, or a time-domain overlap exists between the idle time position within the channel occupancy period and a PSCCH associated with a PSSCH at a determined resource position within the slot, triggering resource reselection in a higher-layer of a device;
in a case where a number of time-domain symbols overlapping between the idle time position within the channel occupancy period and a PSSCH at a determined resource position within the slot and the first preset threshold satisfy the second preset relationship, or a time-domain overlap exists between the idle time position within the channel occupancy period and a PSCCH associated with a PSSCH at a determined resource position within the slot, triggering a device to transmit a scheduling request (SR) or a buffer status report (BSR);
in a case where a number of time-domain symbols overlapping between the idle time position within the channel occupancy period and a candidate PSSCH resource within the slot and the first preset threshold satisfy the second preset relationship, or a time-domain overlap exists between the idle time position within the channel occupancy period and a PSCCH resource associated with a candidate PSSCH resource within the slot, excluding all candidate PSSCH resources on the slot from an initial candidate PSSCH resource set of a physical layer;
in a case where a number of time-domain symbols overlapping between the idle time position within the channel occupancy period and a candidate PSSCH resource within the slot and the first preset threshold satisfy the second preset relationship, or a time-domain overlap exists between the idle time position within the channel occupancy period and a PSCCH resource associated with a candidate PSSCH resource within the slot, excluding all candidate PSSCH resources on the slot from a sensed candidate resource set to be reported of the physical layer;
in a case where a number of time-domain symbols overlapping between the idle time position within the channel occupancy period and a candidate PSSCH resource within the slot and the first preset threshold satisfy the second preset relationship, or a time-domain overlap exists between the idle time position within the channel occupancy period and a PSCCH resource associated with a candidate PSSCH resource within the slot, excluding all candidate PSSCH resources on the slot from a candidate resource set of a medium access control (MAC) layer within a resource selection window;
in a case where a number of available PSSCH symbols, which remain in the slot and exclude symbols overlapping between the idle time position within the channel occupancy period and a PSSCH at a determined resource position within the slot, and a second preset threshold satisfy the second preset relationship, allowing the PSSCH within the slot to be used for puncturing transmission or rate-matching transmission;
in a case where a number of available PSSCH symbols, which remain in the slot and exclude symbols overlapping between the idle time position within the channel occupancy period and a PSSCH at a determined resource position within the slot, and the second preset threshold satisfy the second preset relationship, and no time-domain overlap exists between the idle time position within the channel occupancy period and a PSCCH associated with the PSSCH with the determined resource position within the slot, allowing the PSSCH within the slot to be used for puncturing transmission or rate-matching transmission;
in a case where a number of available PSSCH symbols, which remain in the slot and exclude symbols overlapping between the idle time position within the channel occupancy period and a PSSCH at a determined resource position within the slot, and the second preset threshold satisfy the first preset relationship, or a time-domain overlap exists between the idle time position within the channel occupancy period and a PSCCH associated with a PSSCH at a determined resource position within the slot, dropping the PSSCH transmission within the slot;
in a case where a number of available PSSCH symbols, which remain in the slot and exclude symbols overlapping between the idle time position within the channel occupancy period and a PSSCH at a determined resource position within the slot, and the second preset threshold satisfy the first preset relationship, or a time-domain overlap exists between the idle time position within the channel occupancy period and a PSCCH associated with a PSSCH at a determined resource position within the slot, triggering resource reselection in a higher-layer of a device;
in a case where a number of available PSSCH symbols, which remain in the slot and exclude symbols overlapping between the idle time position within the channel occupancy period and a PSSCH at a determined resource position within the slot, and the second preset threshold satisfy the first preset relationship, or a time-domain overlap exists between the idle time position within the channel occupancy period and a PSCCH associated with a PSSCH at a determined resource position within the slot, triggering a device to transmit an SR or a BSR;
in a case where a number of available PSSCH symbols, which remain in the slot and exclude symbols overlapping between the idle time position within the channel occupancy period and a PSSCH at a determined resource position within the slot, and the second preset threshold satisfy the first preset relationship, or a time-domain overlap exists between the idle time position within the channel occupancy period and a PSCCH resource associated with a candidate PSSCH resource within the slot, excluding all candidate PSSCH resources on the slot from an initial candidate PSSCH resource set of a physical layer;
in a case where a number of available PSSCH symbols, which remain in the slot and exclude symbols overlapping between the idle time position within the channel occupancy period and a PSSCH at a determined resource position within the slot, and the second preset threshold satisfy the first preset relationship, or a time-domain overlap exists between the idle time position within the channel occupancy period and a PSCCH resource associated with a candidate PSSCH resource within the slot, excluding all candidate PSSCH resources on the slot from a sensed candidate resource set to be reported of the physical layer; or
in a case where a number of available PSSCH symbols, which remain in the slot and exclude symbols overlapping between the idle time position within the channel occupancy period and a PSSCH at a determined resource position within the slot, and the second preset threshold satisfy the first preset relationship, or a time-domain overlap exists between the idle time position within the channel occupancy period and a PSCCH resource associated with a candidate PSSCH resource within the slot, excluding all candidate PSSCH resources on the slot from a candidate resource set within a resource selection window of a MAC layer.

16. The method according to claim 14, wherein the second availability rule comprises at least one of the following:
shifting a time-domain position of a PSFCH transmission within the slot;
shifting a time-domain position of a PSFCH transmission between slots;
excluding the slot from the resource pool in a case where time-domain resources of the PSFCH are mapped; or
stopping a PSFCH transmission in the slot.

17. The method according to claim 16, wherein the second availability rule is configured by radio resource control (RRC), preconfigured, or predefined.

18. The method according to claim 14, wherein the third availability rule comprises at least one of the following:
in a case where a time-domain position of a PSFCH transmission is shifted within the slot, and no time-domain overlap exists between a shifted time-domain position of the PSFCH transmission and a PSCCH associated with a PSSCH at a determined resource position within the slot, and a number of available PSSCH symbols remaining in the slot after the shift and a second preset threshold satisfy a second preset relationship, allowing the remaining PSSCH symbols in the slot to be used for puncturing transmission or rate-matching transmission;
in a case where a time-domain position of a PSFCH transmission is shifted within the slot, and a number of available PSSCH symbols remaining in the slot after the shift and the second preset threshold satisfy the second preset relationship, allowing the remaining PSSCH symbols in the slot to be used for puncturing transmission or rate-matching transmission;
in a case where a time-domain position of a PSFCH transmission is shifted within the slot, and a time-domain overlap exists between a shifted time-domain position of the PSFCH transmission and a PSCCH associated with a PSSCH at a determined resource position within the slot, or a number of available PSSCH symbols remaining in the slot after the shift and the second preset threshold satisfy a first preset relationship, dropping the PSSCH transmission within the slot;
in a case where a time-domain position of a PSFCH transmission is shifted within the slot, and a time-domain overlap exists between a shifted time-domain position of the PSFCH transmission and a PSCCH associated with a candidate PSSCH resource within the slot, or a number of available symbols of a candidate PSSCH resource remaining in the slot after the shift and the second preset threshold satisfy the first preset relationship, excluding all candidate PSSCH resources on the slot from an initial candidate PSSCH resource set of a physical layer;
in a case where a time-domain position of a PSFCH transmission is shifted within the slot, and a time-domain overlap exists between a shifted time-domain position of the PSFCH transmission and a PSCCH associated with a candidate PSSCH resource within the slot, or a number of available symbols of a candidate PSSCH resource remaining in the slot after the shift and the second preset threshold satisfy the first preset relationship, excluding all candidate PSSCH resources on the slot from a sensed candidate resource set to be reported of the physical layer;
in a case where a time-domain position of a PSFCH transmission is shifted within the slot, and a time-domain overlap exists between a shifted time-domain position of the PSFCH transmission and a PSCCH associated with a candidate PSSCH resource within the slot, or a number of available symbols of a candidate PSSCH resource remaining in the slot after the shift and the second preset threshold satisfy the first preset relationship, excluding all candidate PSSCH resources on the slot from a candidate resource set within a resource selection window of a MAC layer;
in a case where a time-domain position of a PSFCH transmission is shifted within the slot, and a time-domain overlap exists between a shifted time-domain position of the PSFCH transmission and a PSCCH associated with a PSSCH at a determined resource position within the slot, or a number of available PSSCH symbols remaining in the slot after the shift and the second preset threshold satisfy the first preset relationship, triggering resource reselection in a higher-layer of a device;
in a case where a time-domain position of a PSFCH transmission within the slot, and a time-domain overlap exists between a shifted time-domain position of the PSFCH transmission and a PSCCH associated with a PSSCH at a determined resource position within the slot, or a number of available PSSCH symbols remaining in the slot after the shift and the second preset threshold satisfy the first preset relationship, triggering a device to transmit an SR or a BSR;
in a case where a number of time-domain symbols overlapping between the idle time position within the channel occupancy period and a PSSCH at a determined resource position within the slot and a third preset threshold satisfy the first preset relationship, and a time-domain position of the PSFCH transmission is shifted within the slot, allowing the PSSCH within the slot to be used for puncturing transmission or rate-matching transmission;
in a case where a number of time-domain symbols overlapping between the idle time position within the channel occupancy period and a PSSCH at a determined resource position within the slot and the third preset threshold satisfy the first preset relationship, and a time-domain position of a PSFCH transmission is shifted within the slot, and no time-domain overlap exists between a shifted time-domain position of the PSFCH transmission and a PSCCH associated with the PSSCH with the determined resource position within the slot, allowing the PSSCH within the slot to be used for puncturing transmission or rate-matching transmission;
in a case where a number of time-domain symbols overlapping between the idle time position within the channel occupancy period and a PSSCH at a determined resource position within the slot and the third preset threshold satisfy a second preset relationship, or a time-domain position of a PSFCH transmission is shifted within the slot and a time-domain overlap exists between a shifted time-domain position of the PSFCH transmission and a PSCCH associated with a PSSCH at a determined resource position within the slot, dropping the PSSCH transmission within the slot;
in a case where a number of time-domain symbols overlapping between the idle time position within the channel occupancy period and a PSSCH at a determined resource position within the slot and the third preset threshold satisfy the second preset relationship, or a time-domain position of a PSFCH transmission is shifted within the slot and a time-domain overlap exists between a shifted time-domain position of the PSFCH transmission and a PSCCH associated with a PSSCH at a determined resource position within the slot, triggering resource reselection in a higher-layer of a device;
in a case where a number of time-domain symbols overlapping between the idle time position within the channel occupancy period and a PSSCH at a determined resource position within the slot and the third preset threshold satisfy the second preset relationship, or a time-domain position of a PSFCH transmission is shifted within the slot and a time-domain overlap exists between a shifted time-domain position of the PSFCH transmission and a PSCCH associated with a PSSCH at a determined resource position within the slot, triggering a device to transmit an SR or a BSR;
in a case where a number of time-domain symbols overlapping between the idle time position within the channel occupancy period and a candidate PSSCH resource within the slot and the third preset threshold satisfy the second preset relationship, or a time-domain position of a PSFCH transmission is shifted within the slot and a time-domain overlap exists between a shifted time-domain position of the PSFCH transmission and a PSCCH associated with a candidate PSSCH resource within the slot, excluding all candidate PSSCH resources on the slot from an initial candidate PSSCH resource set of a physical layer;
in a case where a number of time-domain symbols overlapping between the idle time position within the channel occupancy period and a candidate PSSCH resource within the slot and the third preset threshold satisfy the second preset relationship, or a time-domain position of a PSFCH transmission is shifted within the slot and a time-domain overlap exists between a shifted time-domain position of the PSFCH transmission and a PSCCH associated with a candidate PSSCH resource within the slot, excluding, all candidate PSSCH resources on the slot from a sensed candidate resource set to be reported of a physical layer;
in a case where a number of time-domain symbols overlapping between the idle time position within the channel occupancy period and a candidate PSSCH resource within the slot and the third preset threshold satisfy the second preset relationship, or a time-domain position of a PSFCH transmission is shifted within the slot and a time-domain overlap exists between a shifted time-domain position of the PSFCH transmission and a PSCCH associated with a candidate PSSCH resource within the slot, excluding all candidate PSSCH resources on the slot from a candidate resource set within a resource selection window of a MAC layer;
shifting a time-domain position of a PSFCH transmission between slots and executing the first availability rule;
excluding the slot from the resource pool in a case where time-domain resources of the PSFCH are mapped and executing the first availability rule; or
stopping a PSFCH transmission in the slot and executing the first availability rule.

19. The method according to claim 16, wherein shifting the time-domain position of the PSFCH transmission within the slot comprises:
the slot comprising L symbols with corresponding symbol indices from S to S+L−1, wherein an index of a symbol with a smallest index among symbols overlapping between the idle time position within the channel occupancy period and the L symbols within the slot of the resource pool is Q, indices of available symbols within the slot are from S to Q−1, and a last symbol index allowed for the PSFCH transmission within the slot is Q−1;
a number of symbols by which PSFCH symbols are shifted within the slot being P−Q+1, wherein an index of a second symbol for the PSFCH transmission before the shift is P, and an index of a second symbol for the PSFCH transmission after the shift is Q−1;
a number of symbols by which PSFCH symbols are shifted within the slot being P−Q+1, wherein an index of a second symbol for the PSFCH transmission before the shift is P, and an index of a second symbol for the PSFCH transmission after the shift is S+1;
a number of symbols by which PSFCH symbols are shifted within the slot being P−Q+1, wherein an index of a second symbol for the PSFCH transmission before the shift is P, and an index of a second symbol for the PSFCH transmission after the shift is between S+1 and Q−1;
in a case where Q−S is greater than or equal to a fourth preset threshold, a number of symbols by which PSFCH symbols are shifted within the slot being P−Q+1, wherein an index of a second symbol for the PSFCH transmission before the shift is P, and an index of a second symbol for the PSFCH transmission after the shift is Q−1;
in a case where Q−S is greater than or equal to a fourth preset threshold, a number of symbols by which PSFCH symbols are shifted within the slot being P−Q+1, wherein an index of a second symbol for the PSFCH transmission before the shift is P, and an index of a second symbol for the PSFCH transmission after the shift is S+1;
in a case where Q−S is greater than or equal to a fourth preset threshold, a number of symbols by which PSFCH symbols are shifted within the slot being P−Q+1, wherein an index of a second symbol for the PSFCH transmission before the shift is P, and an index of a second symbol for the PSFCH transmission after the shift is between S+1 and Q−1; and
in a case where Q−S is less than a fourth preset threshold, shifting the time-domain position of the PSFCH transmission between slots, excluding the slot from the resource pool in a case where time-domain resources of the PSFCH are mapped, or stopping the PSFCH transmission in the slot, according to a configuration, a preconfiguration, or a predefinition.

20. The method according to claim 16, wherein
after shifting the time-domain position of the PSFCH transmission between slots, the time-domain position of the PSFCH transmission is an index symbol for the PSFCH transmission before the shift plus 12 or 14, or the time-domain position of the PSFCH transmission is an index symbol for the PSFCH transmission before the shift minus 12 or 14.

21. A communication node, comprising: a processor configured to, when executing a computer program, implement the following steps:
acquiring resource pool configuration information and semi-static channel occupancy information;
determining a resource position and a transmission mode of a channel based on the resource pool configuration information and the semi-static channel occupancy information, wherein the channel is a data channel or a feedback channel; and
transmitting data at the resource position according to the transmission mode.

22. A non-transitory computer-readable storage medium storing a computer program that, when executed by a processor, implements the following steps:
acquiring resource pool configuration information and semi-static channel occupancy information;
determining a resource position and a transmission mode of a channel based on the resource pool configuration information and the semi-static channel occupancy information, wherein the channel is a data channel or a feedback channel; and
transmitting data at the resource position according to the transmission mode.
